(19) United States
(12) Patent Application Publication
(10) Pub. No.: US 2025/0106065 A1
(43) Pub. Date: Mar. 27, 2025

(54) COMMUNICATION SYSTEM

(71) Applicant: DENSO CORPORATION, Kariya-city (JP)

(72) Inventors: Ryota KAMEOKA, Kariya-city (JP); Tomohisa KISHIGAMI, Kariya-city (JP); Tomoya TOKUNAGA, Kariya-city (JP); Akira TADA, Kariya-city (JP)

(21) Appl. No.: 18/895,474

(22) Filed: Sep. 25, 2024

(30) Foreign Application Priority Data
Sep. 27, 2023 (JP) 2023-166037
Aug. 29, 2024 (JP) 2024-147515

(51) Int. Cl. H04L 12/40; G06F 1/3296; G07C 5/08

(52) U.S. Cl. CPC H04L 12/40039; G06F 1/3296; G07C 5/0808; H04L 12/40045; H04L 2012/40215; H04L 2012/40273

(57) ABSTRACT

A communication system includes a first control device that receives a power supply from a power source via a power supply switching section configured to switch between a conduction state and a cutoff state and a second control device that is data-communicably connected to the first control device and controls an operation of the power supply switching section. The second control device includes a state confirmation section that determines whether the first control device is in a cutoff-allowable state and a power supply control section that brings the power supply switching section into the cutoff state when the state confirmation section determines that the first control device is in the cutoff-allowable state.

### CROSS REFERENCE TO RELATED APPLICATION

This application is based on Japanese Patent Application No. 2023-166037 filed on Sep. 27, 2023, and Japanese Patent Application No. 2024-147515 filed on Aug. 29, 2024, the disclosures of which are incorporated herein by reference.

### TECHNICAL FIELD

The present disclosure relates to a communication system including a plurality of control devices.

### BACKGROUND

A rerated art describes an in-vehicle network system that includes a power supply relay that individually switches on/off of a power source of an electronic control device for each of a plurality of electronic control devices, determines a control content for switching on/off of the power source of a specific electronic control device for the specific electronic control device corresponding to a scene identified based on a situation of a vehicle, and switches on/off of the power source supplied to the specific electronic control device using the power supply relay based on the determined control content.

### SUMMARY

A communication system includes a first control device that receives a power supply from a power source via a power supply switching section configured to switch between a conduction state and a cutoff state and a second control device that is data-communicably connected to the first control device and controls an operation of the power supply switching section. The second control device includes a state confirmation section that determines whether the first control device is in a cutoff-allowable state and a power supply control section that brings the power supply switching section into the cutoff state when the state confirmation section determines that the first control device is in the cutoff-allowable state.

### BRIEF DESCRIPTION OF DRAWINGS

FIG. 1 is a block diagram illustrating a configuration of a communication system according to the first, second, third, and fourth embodiments.

FIG. 2 is an explanatory diagram illustrating affiliation information and activation information.

FIG. 3 is a flowchart illustrating a management process according to the first embodiment.

FIG. 4 is a flowchart illustrating a response process according to the first embodiment.

FIG. 5 is a sequence diagram illustrating a procedure for turning off a relay in the first embodiment.

FIG. 6 is a flowchart illustrating a management process according to the second embodiment.

FIG. 7 is a flowchart illustrating a response process according to the second embodiment.

FIG. 8 is a sequence diagram illustrating a procedure for turning off a relay in the second embodiment.

FIG. 9 is a flowchart illustrating a notification process according to the third embodiment.

FIG. 10 is a flowchart illustrating a management process according to the third embodiment.

FIG. 11 is a sequence diagram illustrating a procedure for turning off a relay in the third embodiment.

FIG. 12 is a flowchart illustrating a request process according to the fourth embodiment.

FIG. 13 is a flowchart illustrating a management process according to the fourth embodiment.

FIG. 14 is a sequence diagram illustrating a procedure for turning off a relay in the fourth embodiment.

FIG. 15 is a block diagram illustrating a configuration of a communication system according to the fifth embodiment.

FIG. 16 is a flowchart illustrating a management process according to the fifth embodiment.

FIG. 17 is a diagram illustrating a configuration of a management table.

FIG. 18 is a block diagram illustrating a configuration of a communication system according to the sixth embodiment.

FIG. 19 is a diagram illustrating a correspondence relationship between control targets and clusters.

FIG. 20 is a block diagram illustrating a configuration of a communication system according to the seventh embodiment.

FIG. 21 is a block diagram illustrating a configuration of a central ECU and an upstream power distribution section according to the seventh embodiment.

FIG. 22 is a first block diagram illustrating a configuration of a zone ECU according to the seventh embodiment.

FIG. 23 is a second block diagram illustrating a configuration of a zone ECU according to the seventh embodiment.

FIG. 24 is a block diagram illustrating a configuration of a slave ECU according to the seventh embodiment.

FIG. 25 is a sequence diagram illustrating a procedure for turning off an electronic fuse in the seventh embodiment.

FIG. 26 is a sequence diagram illustrating a procedure for turning off an electronic fuse in the eighth embodiment.

FIG. 27 is a sequence diagram illustrating a procedure for turning off an electronic fuse in the ninth embodiment.

FIG. 28 is a sequence diagram illustrating a procedure for turning off an electronic fuse in the eleventh embodiment.

FIG. 29 is a sequence diagram illustrating a procedure for turning off an electronic fuse in the twelfth embodiment.

FIG. 30 is a sequence diagram illustrating a procedure for turning off an electronic fuse in the thirteenth embodiment.

FIG. 31 is a sequence diagram illustrating a procedure for turning off an electronic fuse in the fourteenth embodiment.

FIG. 32 is a sequence diagram illustrating a procedure for turning off an electronic fuse in the fifteenth embodiment.

FIG. 33 is a sequence diagram illustrating a procedure for turning off an electronic fuse in the sixteenth embodiment.

### DETAILED DESCRIPTION

As a result of detailed studies by the inventors, the following difficulty has been found. The relay may switch from the on state to the off state even when the power supply to the control device should not be cut off, or the relay may remain in the on state even when the power supply to the control device can be cut off.

The present disclosure provides a technique to improve the reliability of control for supplying power to the control device.

According to one aspect of the present disclosure, a communication system includes a first control device configured to receive a power supply from a power source via a power supply switching section configured to switch between a conduction state in which a power supply path is conducted and a cutoff state in which the power supply path is cut off, and a second control device that is data-communicably connected to the first control device and is configured to control an operation of the power supply switching section. The second control device includes a state confirmation section configured to determine whether the first control device is in a cutoff-allowable state in which the power supply switching section may be brought into the cutoff state, and a power supply control section configured to bring the power supply switching section into the cutoff state when the state confirmation section determines that the first control device is in the cutoff-allowable state.

The state confirmation section is configured to determine whether the first control device is in a cutoff-allowable state in which the power supply switching section may be in the cutoff state. The power supply control section is configured to bring the power supply switching section into the cutoff state when the state confirmation section determines that the first control device is in the cutoff-allowable state.

In the communication system of the present disclosure configured as described above, it is determined whether the first control device is in the cutoff-allowable state, and the power supply switching section is brought into the cutoff state when the first control device is in the cutoff-allowable state. This prevents the occurrence of a situation where the power supply switching section is switched from the conduction state to the cutoff state even when the power supply to the first control device should not be cut off, or the power supply switching section remains in the conduction state even when the power supply to the first control device can be cut off. Therefore, the communication system of the present disclosure can improve the reliability of control for supplying power to the control device.

### First Embodiment

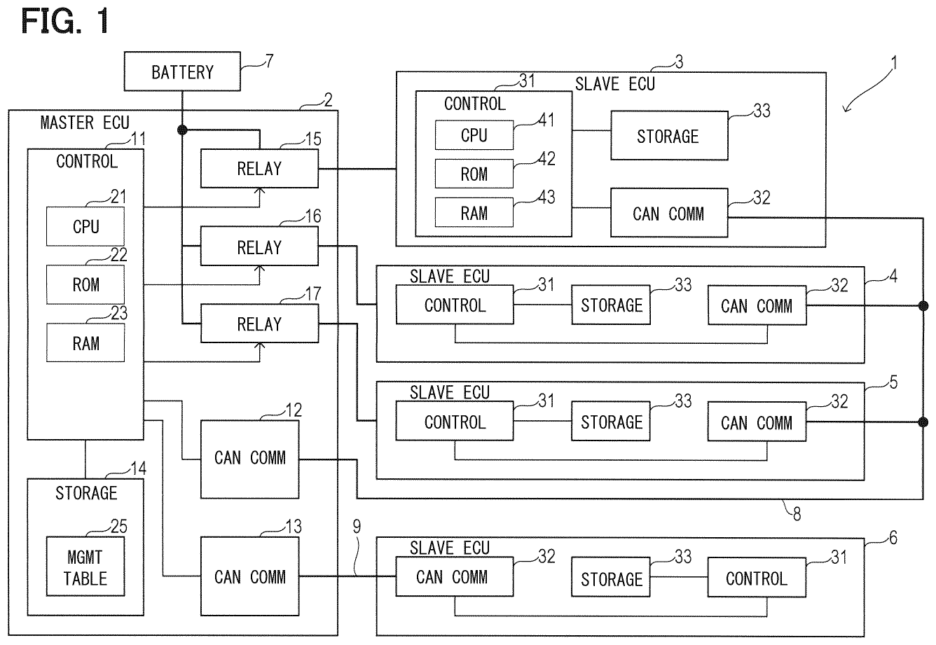

The first embodiment of the present disclosure will be described with reference to the drawings. The communication system 1 of the present embodiment is mounted on a vehicle and includes a master ECU 2, slave ECUs 3, 4, 5, and 6, and a battery 7 as illustrated in FIG. 1. ECU stands for Electronic Control Unit. Hereinafter, the master ECU 2 and the slave ECUs 3 to 6 are collectively referred to as nodes.

The master ECU 2 and the slave ECUs 3, 4, and 5 are data-communicably connected to each other via a communication bus 8. The master ECU 2 and the slave ECU 6 are data-communicably connected to each other via a communication bus 9.

The battery 7 supplies power to each section of the vehicle with a direct-current battery voltage (for example, 12 V). The master ECU 2 and the slave ECUs 3 to 6 operate by receiving a power supply from the battery 7.

The master ECU 2 includes a control section 11, CAN communication sections 12 and 13, a storage section 14, and relays 15, 16, and 17. CAN stands for Controller Area Network. The communication protocol of the communication system 1 is not limited to CAN.

The control section 11 is an electronic control device mainly including a microcomputer including a CPU 21, a ROM 22, a RAM 23, and the like. Various functions of the microcomputer are implemented by the CPU 21 executing a program stored in a non-transitory tangible storage medium. In this example, the ROM 22 corresponds to a non-transitory tangible storage medium storing a program. Further, by executing this program, a method corresponding to the program is executed. Some or all of the functions executed by the CPU 21 may be configured as hardware by one or a plurality of ICs or the like. Furthermore, the number of microcomputers constituting the control section 11 may be one or more.

The CAN communication section 12 performs communication with the slave ECUs 3, 4, and 5 connected to the communication bus 8 by transmitting and receiving a communication frame based on the CAN communication protocol. The CAN communication section 13 performs communication with the slave ECU 6 connected to the communication bus 9 by transmitting and receiving a communication frame based on the CAN communication protocol. Hereinafter, a communication frame of CAN is referred to as a CAN frame.

The storage section 14 is a storage device for storing various pieces of data. The storage section 14 stores a management table 25 to be described later. The relay 15 is disposed on a power supply path between the battery 7 and the slave ECU 3. The relay 16 is disposed on a power supply path between the battery 7 and the slave ECU 4. The relay 17 is disposed on a power supply path between the battery 7 and the slave ECU 5.

The relays 15, 16, and 17 are configured to switch between a conduction state in which the power supply path is conducted and a cutoff state in which the power supply path is cut off in accordance with a command from the control section 11. Hereinafter, the conduction state is also referred to as an on state, and the cutoff state is also referred to as an off state.

The slave ECUs 3 to 6 include a control section 31, a CAN communication section 32, and a storage section 33. The control section 31 is an electronic control device mainly including a microcomputer including a CPU 41, a ROM 42, a RAM 43, and the like. Various functions of the microcomputer are implemented by the CPU 41 executing a program stored in a non-transitory tangible storage medium. In this example, the ROM 42 corresponds to a non-transitory tangible storage storing a program. Further, by executing this program, a method corresponding to the program is executed. Some or all of the functions executed by the CPU 41 may be configured as hardware by one or a plurality of ICs or the like. Furthermore, the number of microcomputers constituting the control section 31 may be one or more.

The CAN communication section 32 of the slave ECUs 3 to 5 performs communication with communication devices (that is, the master ECU 2 and the slave ECUs 3 to 5) connected to the communication bus 8 based on the CAN communication protocol.

The CAN communication section 32 of the slave ECU 6 performs communication with a communication device (that is, the master ECU 2) connected to the communication bus 9 based on the CAN communication protocol. The storage section 33 is a storage device for storing various pieces of data.

The CAN frame includes a start of frame, an arbitration field, a control field, a data field, a CRC field, an ACK field, and an end of frame. The arbitration field includes an 11-bit or 29-bit identifier (that is, ID) and a 1-bit RTR bit.

An 11-bit identifier used in CAN communication is referred to as a CAN ID. The CAN ID is preset based on the content of data included in the CAN frame, the transmission source of the CAN frame, the transmission destination of the CAN frame, and the like.

The data field is a payload including first data, second data, third data, fourth data, fifth data, sixth data, seventh data, and eighth data each of which has 8 bits (that is, one byte).

The communication system 1 forms a partial network, which is a power supply control method based on communication control of the CAN protocol standard specified in ISO 11898-6. Therefore, the communication system 1 achieves low power consumption by individually transitioning one or more nodes belonging to a communication group to a wake-up state (that is, an activation state) or a sleep state (that is, a dormancy state) for each communication group to be described later. When a node wakes up, it transitions to a normal operation state in which functions assigned to the node can be used without restriction, and when it sleeps, it transitions to a low power consumption operation state in which available functions are restricted.

In the communication system 1, an NM frame, which is a CAN frame including activation information for specifying an activation group, is used to wake up a node in the sleep state. NM stands for Network Management.

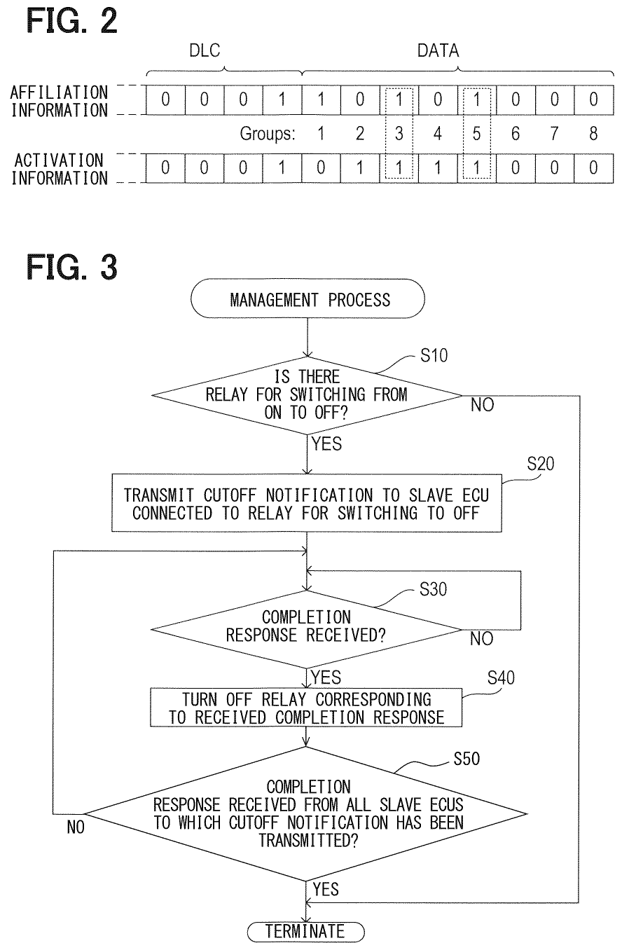

The activation information is set as illustrated in FIG. 2, for example. DLC stands for Data Length Code, and is a region representing the size of a data field in a CAN frame in byte units. That is, the activation information is stored in the data field of the CAN frame. Here, in order to simplify the description, a case where DLC is 1 byte (that is, 8 bits) will be described. An activation group is associated with each bit of the 8-bit data representing the activation information. An activation group may be associated with a data sequence of one or more bits.

The activation information set in the NM frame has a bit corresponding to the activation group to be activated set to 1. Each node stores affiliation information indicating the activation group to which the node belongs. The affiliation information has the same data length as the activation information, and the bit allocation is the same as that of the activation information. The affiliation information has a bit corresponding to the activation group to which the node belongs set to 1.

Each node determines whether the communication group to which the node belongs is an activation target by comparing the activation information extracted from the NM frame with the affiliation information stored in the node.

For example, the affiliation information illustrated in FIG. 2 indicates that the node belongs to the first communication group, the third communication group, and the fifth communication group. The activation information illustrated in FIG. 2 indicates that the second communication group, the third communication group, the fourth communication group, and the fifth communication group are to be activated. Since the third communication group and the fifth communication group are included in both the affiliation information and the activation information illustrated in FIG. 2, the node determines that it is an activation target as the third communication group and the fifth communication group.

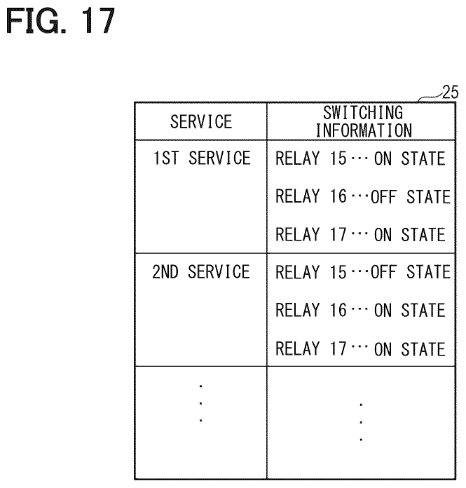

The management table 25 illustrated in FIG. 1 sets a correspondence relationship between a service and switching information for each of a plurality of services provided to an occupant of a vehicle using the master ECU 2 and the slave ECUs 3 to 6 as illustrated in FIG. 17.

The management table 25 specifies, for example, for the first service, that the relay 15 is turned on as the switching information of the relay 15, that the relay 16 is turned off as the switching information of the relay 16, and that the relay 17 is turned on as the switching information of the relay 17.

The management table 25 specifies, for example, for the second service, that the relay 15 is turned off as the switching information of the relay 15, that the relay 16 is turned on as the switching information of the relay 16, and that the relay 17 is turned on as the switching information of the relay 17.

When the slave ECUs 3 to 6 detect that a service start condition is satisfied, they transmit a service request requesting execution of the corresponding service to the master ECU 2. When the master ECU 2 receives the service request, it extracts the switching information corresponding to the corresponding service from the management table 25, and turns on or off the relays 15, 16, and 17 based on the extracted switching information.

When the master ECU 2 detects that a service start condition is satisfied, the master ECU 2 extracts the switching information corresponding to the corresponding service from the management table 25, and turns on or off the relays 15, 16, and 17 based on the extracted switching information.

Next, a procedure of the management process executed by the control section 11 of the master ECU 2 will be described. The management process is a process repeatedly executed during activation of the master ECU 2. When the management process is executed, in S10, the CPU 21 of the control section 11 determines whether it is necessary to switch at least one of the relays 15, 16, and 17 from the on state to the off state as illustrated in FIG. 3. Specifically, the CPU 21 determines whether it is necessary to switch the relays 15, 16, and 17 from the on state to the off state based on the switching information extracted from the management table 25 due to receiving a service request from the slave ECUs 3 to 6. The CPU 21 also determines whether it is necessary to switch the relays 15, 16, and 17 from the on state to the off state based on the switching information extracted from the management table 25 due to the master ECU 2 detecting that a service start condition is satisfied.

In a state where a plurality of service requests are received or a state where a plurality of service start conditions are satisfied, the relays are turned on by the OR (that is, logical sum) of the switching information, and the relays are turned off by the AND (that is, logical product) of the switching information.

Here, in a case where it is not necessary to switch the relays 15, 16, and 17 from the on state to the off state, the CPU 21 terminates the management process. On the other hand, in a case where it is necessary to switch at least one of the relays 15, 16, and 17 from the on state to the off state, the CPU 21 transmits a cutoff notification indicating to cut off the power supply to the slave ECUs 3, 4, and 5 connected to the relays 15, 16, and 17 to be switched from the on state to the off state in S20. For example, in a case where the relay 16 is to be switched from the on state to the off state, the CPU 21 transmits a cutoff notification to the slave ECU 4.

In S30, the CPU 21 determines whether a completion response has been received from the slave ECU to which the cutoff notification has been transmitted. Here, in a case where the completion response has not been received, the CPU 21 waits until the completion response is received by repeating the process of S30.

When the completion response is received, the CPU 21 switches the relay connected to the slave ECU that is the transmission source of the received completion response to the off state in S40. For example, in a case where the transmission source of the received completion response is the slave ECU 4, the CPU 21 switches the relay 16 to the off state.

In S50, the CPU 21 determines whether a completion response has been received from all the slave ECUs to which the cutoff notification has been transmitted. Here, if there is a slave ECU from which the completion response has not been received, the CPU 21 proceeds to S30. On the other hand, if the completion response has been received from all the slave ECUs to which the cutoff notification has been transmitted, the CPU 21 terminates the management process.

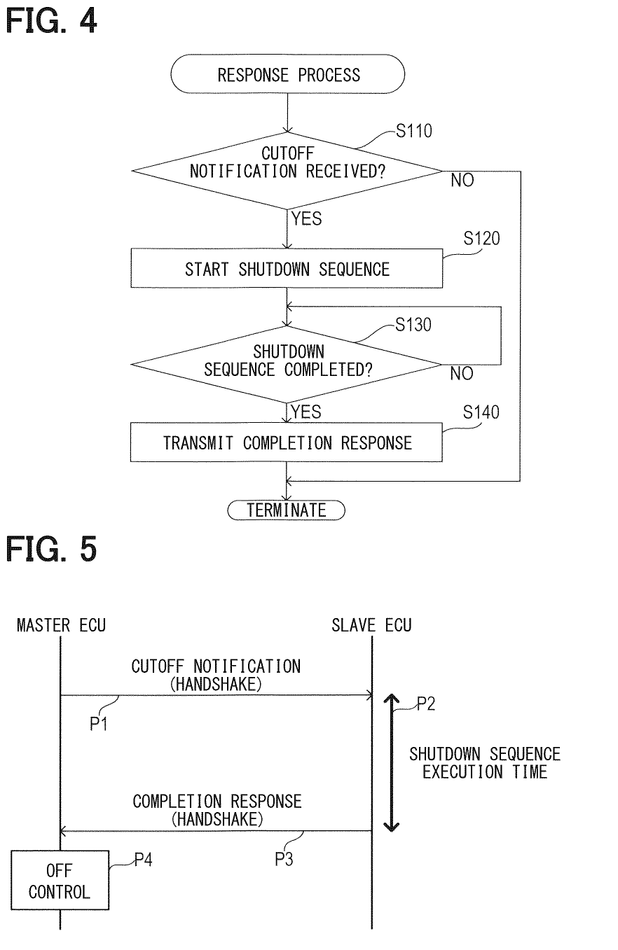

Next, a procedure of the response process executed by the control sections 31 of the slave ECUs 3 to 5 will be described. The response process is a process repeatedly executed during activation of the slave ECUs 3 to 5. When the response process is executed, in S110, the CPU 41 of the control section 31 determines whether a cutoff notification has been received from the master ECU 2 as illustrated in FIG. 4. Here, if the cutoff notification has not been received, the CPU 41 terminates the response process.

On the other hand, if the cutoff notification has been received, the CPU 41 starts a shutdown sequence in S120. The shutdown sequence is a process performed to transition from the wake-up state to the sleep state. For each of the ECUs 2 to 6, processes to be executed in the shutdown sequence are preset. As the shutdown sequence, for example, storing setting value information of an in-vehicle air conditioner can be mentioned.

In S130, the CPU 41 determines whether the shutdown sequence has been completed. Here, if the shutdown sequence has not been completed, the CPU 41 waits until the shutdown sequence is completed by repeating the process of S130.

When the shutdown sequence is completed, the CPU 41 transmits a completion response to the master ECU 2 in S140 and terminates the response process. As illustrated in FIG. 5, after the handshake of the shutdown sequence is executed between the master ECU 2 and the slave ECUs 3 to 5, the relays 15, 16, and 17 are switched from the on state to the off state.

Specifically, as illustrated by process P1 in FIG. 5, the master ECU 2 transmits a cutoff notification to the slave ECUs 3 to 5. The slave ECUs 3 to 5 that have received the cutoff notification execute the shutdown sequence as illustrated by process P2.

When the shutdown sequence is completed, the slave ECUs 3 to 5 transmit a completion response to the master ECU 2 as illustrated by process P3. The master ECU 2 that has received the completion response switches the relays 15, 16, and 17 from the on state to the off state as illustrated by process P4.

The communication system 1 configured as described above includes the slave ECU 3 and the master ECU 2. The slave ECU 3 receives power from the battery 7 via the relay 15 configured to switch between a conduction state in which the power supply path is conducted and a cutoff state in which the power supply path is cut off.

The master ECU 2 is data-communicably connected to the slave ECU 3 and is configured to control the operation of the relay 15. The master ECU 2 is configured to determine whether the slave ECU 3 is in a cutoff-allowable state (hereinafter, cutoff-allowable state) in which the relay 15 may be brought into the cutoff state by performing data communication with the slave ECU 3. Specifically, the master ECU 2 is configured to transmit a cutoff notification indicating to switch the relay 15 to the cutoff state to the slave ECU 3 and to determine that the slave ECU 3 is in the cutoff-allowable state when a completion response indicating that the shutdown sequence has been completed is received from the slave ECU 3.

The master ECU 2 is configured to bring the relay 15 into the cutoff state when it is determined that the slave ECU 3 is in the cutoff-allowable state. Such a communication system 1 can suppress the occurrence of a situation where the relay 15 is switched from the conduction state to the cutoff state even though the power supply to the slave ECU 3 should not be cut off because the shutdown sequence has not been completed. Therefore, the communication system 1 can improve the reliability of control for supplying power to the slave ECU 3.

In the embodiment described above, the slave ECU 3 corresponds to the first control device, the master ECU 2 corresponds to the second control device, the relay 15 corresponds to the power supply switching section, and the battery 7 corresponds to the power source.

Furthermore, S20 to S30 correspond to the process as the state confirmation section, and S40 corresponds to the process as the power supply control section.

### Second Embodiment

Hereinafter, the second embodiment of the present disclosure will be described with reference to the drawings. In the second embodiment, components different from the first embodiment will be described. Common configurations are denoted by the same reference numerals.

The communication system 1 of the second embodiment is different from that of the first embodiment in that the management process and the response process have been changed. Next, a procedure of the management process according to the second embodiment will be described. The management process of the second embodiment is a process repeatedly executed during activation of the master ECU 2.

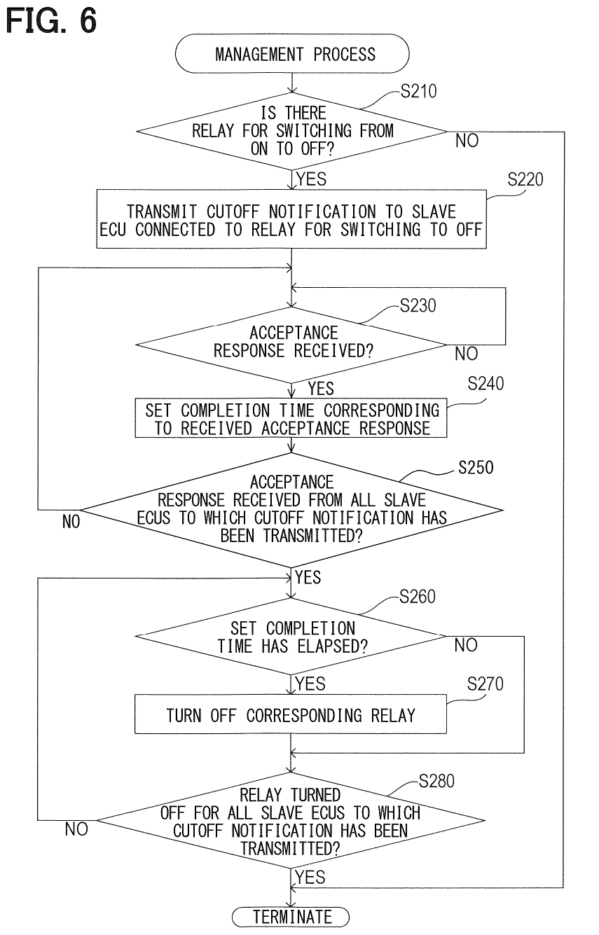

When the management process of the second embodiment is executed, in S210, the CPU 21 of the control section 11 determines whether it is necessary to switch at least one of the relays 15, 16, and 17 from the on state to the off state in the same manner as in S10 as illustrated in FIG. 6. Here, if it is not necessary to switch the relays 15, 16, and 17 from the on state to the off state, the CPU 21 terminates the management process.

On the other hand, if it is necessary to switch at least one of the relays 15, 16, and 17 from the on state to the off state, the CPU 21 transmits a cutoff notification indicating to cut off the power supply to the slave ECUs 3, 4, and 5 connected to the relays 15, 16, and 17 to be switched from the on state to the off state in S220 in the same manner as in S20.

In S230, the CPU 21 determines whether an acknowledgment response has been received from the slave ECU to which the cutoff notification has been transmitted. Here, if the acknowledgment response has not been received, the CPU 21 waits until the acknowledgment response is received by repeating the process of S230.

When the acknowledgment response is received, the CPU 21 extracts completion time information included in the acknowledgment response in S240 and sets the completion time indicated by the extracted completion time information as the waiting time until the relay connected to the slave ECU that is the transmission source of the received acknowledgment response is switched to the off state. For example, if the transmission source of the received acknowledgment response is the slave ECU 4, the CPU 21 sets the completion time indicated by the extracted completion time information as the waiting time until the relay 16 is switched to the off state.

In S250, the CPU 21 determines whether an acknowledgment response has been received from all the slave ECUs to which the cutoff notification has been transmitted. Here, if there is a slave ECU from which the acknowledgment response has not been received, the CPU 21 proceeds to S230.

On the other hand, if the acknowledgment response has been received from all the slave ECUs to which the cutoff notification has been transmitted, the CPU 21 determines whether the completion time set in S240 has elapsed in S260. Here, if the completion time has not elapsed, the CPU 21 proceeds to S280. On the other hand, if the completion time has elapsed, the CPU 21 switches the relay connected to the slave ECU corresponding to the elapsed completion time to the off state in S270 and proceeds to S280.

In S280, it is determined whether the relays connected to all the slave ECUs to which the cutoff notification has been transmitted have been switched to the off state. Here, if there is a slave ECU whose relay has not been switched to the off state, the CPU 21 proceeds to S260. On the other hand, if the relays connected to all the slave ECUs to which the cutoff notification has been transmitted have been switched to the off state, the CPU 21 terminates the management process.

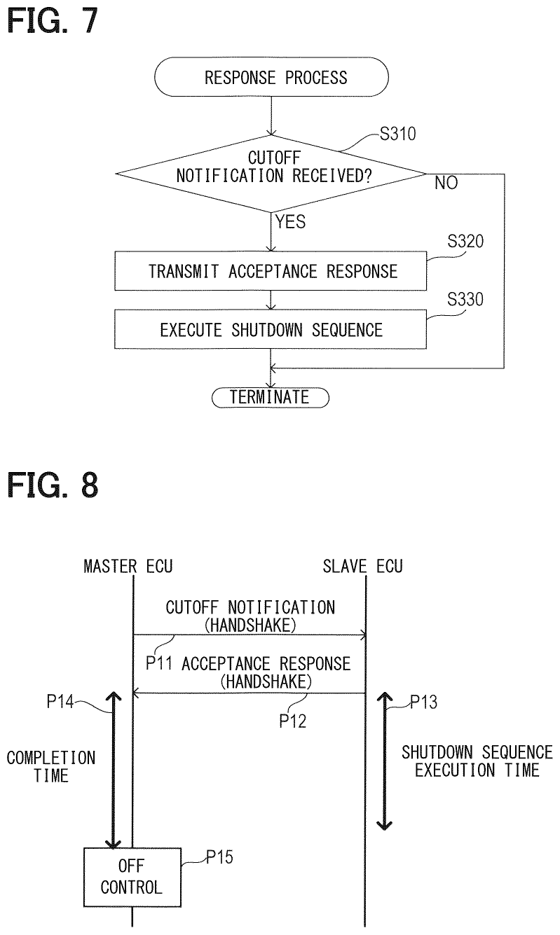

Next, a procedure of the response process according to the second embodiment will be described. The response process of the second embodiment is a process repeatedly executed during activation of the slave ECUs 3 to 5. When the response process of the second embodiment is executed, in S310, the CPU 41 of the control section 31 determines whether a cutoff notification has been received from the master ECU 2 as illustrated in FIG. 7. Here, if the cutoff notification has not been received, the CPU 41 terminates the response process.

On the other hand, if the cutoff notification has been received, the CPU 41 transmits an acknowledgment response to the master ECU 2 in S320. The acknowledgment response includes completion time information indicating a preset completion time as the time required to complete the shutdown sequence after starting it.

In S330, the CPU 41 executes the shutdown sequence and terminates the response process after the shutdown sequence is completed. As illustrated in FIG. 8, after the handshake of the shutdown sequence is executed between the master ECU 2 and the slave ECUs 3 to 5, the relays 15, 16, and 17 are switched from the on state to the off state.

Specifically, as illustrated by process P11 in FIG. 8, the master ECU 2 transmits a cutoff notification to the slave ECUs 3 to 5. The slave ECUs 3 to 5 that have received the cutoff notification transmit an acknowledgment response to the master ECU 2 as illustrated by process P12.

The slave ECUs 3 to 5 that have transmitted the acknowledgment response execute the shutdown sequence as illustrated by process P13. The master ECU 2 that has received the completion response waits until the completion time elapses as illustrated by process P14.

When the completion time elapses, the master ECU 2 switches the relays 15, 16, and 17 from the on state to the off state as illustrated by process P15. The communication system 1 configured as described above includes the slave ECU 3 and the master ECU 2.

The master ECU 2 is configured to determine whether the slave ECU 3 is in a cutoff-allowable state (hereinafter, cutoff-allowable state) in which the relay 15 may be brought into the cutoff state by performing data communication with the slave ECU 3. Specifically, the master ECU 2 is configured to transmit a cutoff notification indicating to switch the relay 15 to the cutoff state to the slave ECU 3, and after transmitting the cutoff notification, when the master ECU 2 receives an acknowledgment response including completion time information indicating the time required to complete the shutdown sequence from the slave ECU 3, the master ECU 2 determines that the slave ECU 3 is in the cutoff-allowable state when the completion time has elapsed after receiving the acknowledgment response.

The master ECU 2 is configured to bring the relay 15 into the cutoff state when it is determined that the slave ECU 3 is in the cutoff-allowable state. Such a communication system 1 can suppress the occurrence of a situation where the relay 15 is switched from the conduction state to the cutoff state even though the power supply to the slave ECU 3 should not be cut off because the shutdown sequence has not been completed. Therefore, the communication system 1 can improve the reliability of control for supplying power to the slave ECU 3.

In the embodiment described above, S220 to S260 correspond to the process as the state confirmation section, and S270 corresponds to the process as the power supply control section.

### Third Embodiment

Hereinafter, the third embodiment of the present disclosure will be described with reference to the drawings. In the third embodiment, components different from the first embodiment will be described. Common configurations are denoted by the same reference numerals.

The communication system 1 of the third embodiment is different from that of the first embodiment in that a notification process is executed instead of the response process, and the management process has been changed. Next, a procedure of the notification process will be described. The notification process is a process repeatedly executed during activation of the slave ECUs 3 to 5.

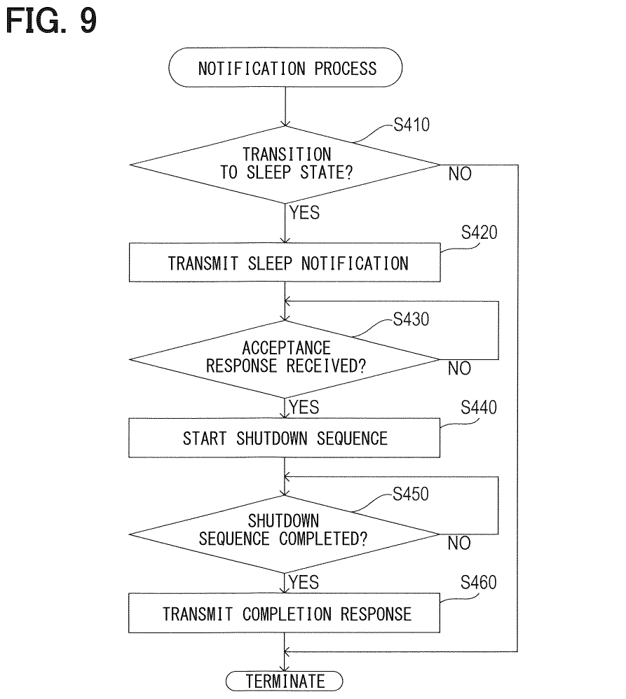

When the notification process is executed, in S410, the CPU 41 of the control section 31 determines whether it is necessary to transition from the wake-up state to the sleep state as illustrated in FIG. 9. Here, if it is not necessary to transition to the sleep state, the notification process is terminated.

On the other hand, if it is necessary to transition from the wake-up state to the sleep state, the CPU 41 transmits a sleep notification indicating to transition to the sleep state to the master ECU 2 in S420.

In S430, the CPU 41 determines whether an acknowledgment response has been received from the master ECU 2. Here, if the acknowledgment response has not been received, the CPU 41 waits until the acknowledgment response is received by repeating the process of S430.

When the acknowledgment response is received, the CPU 41 starts the shutdown sequence in S440. In S450, the CPU 41 determines whether the shutdown sequence has been completed. Here, if the shutdown sequence has not been completed, the CPU 41 waits until the shutdown sequence is completed by repeating the process of S450.

When the shutdown sequence is completed, the CPU 41 transmits a completion response to the master ECU 2 in S460 and terminates the response process. Next, a procedure of the management process according to the third embodiment will be described. The management process of the third embodiment is a process repeatedly executed during activation of the master ECU 2.

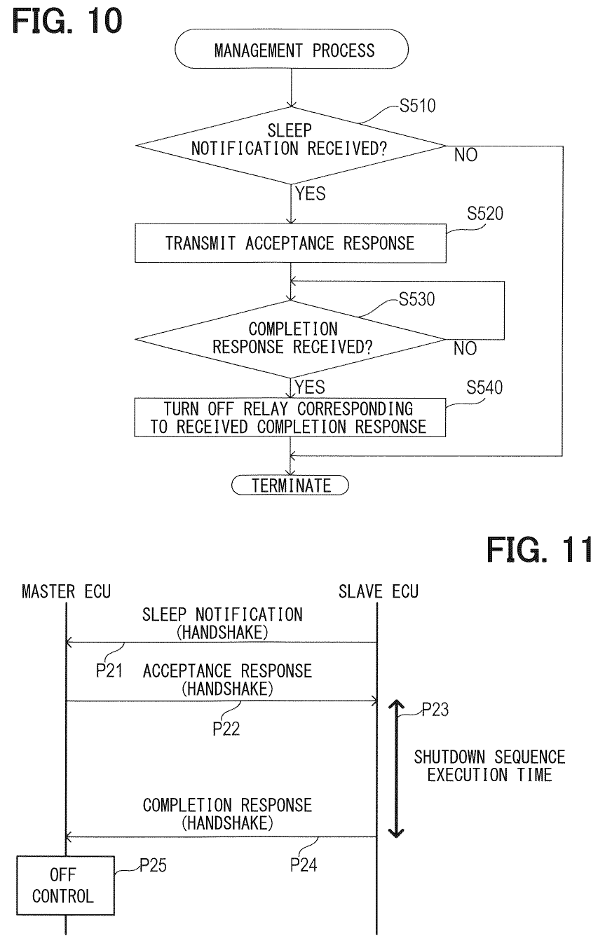

When the management process of the third embodiment is executed, in S510, the CPU 21 of the control section 11 determines whether a sleep notification has been received from the slave ECUs 3 to 5 as illustrated in FIG. 10. Here, if the sleep notification has not been received, the CPU 21 terminates the management process.

On the other hand, if the sleep notification has been received, the CPU 21 transmits an acknowledgment response to the slave ECU that is the transmission source of the received sleep notification in S520. In S530, the CPU 21 determines whether a completion response has been received from the slave ECU to which the acknowledgment response has been transmitted. Here, if the completion response has not been received, the CPU 21 waits until the completion response is received by repeating the process of S530.

When the completion response is received, the CPU 21 switches the relay connected to the slave ECU that is the transmission source of the received completion response to the off state in S540 and terminates the management process.

As illustrated in FIG. 11, after the handshake of the shutdown sequence is executed between the master ECU 2 and the slave ECUs 3 to 5, the relays 15, 16, and 17 are switched from the on state to the off state.

Specifically, as illustrated by process P21 in FIG. 11, the slave ECUs 3 to 5 transmit a sleep notification to the master ECU 2. The master ECU 2 that has received the sleep notification transmits an acknowledgment response to the slave ECUs 3 to 5 as illustrated by process P22.

The slave ECUs 3 to 5 that have transmitted the acknowledgment response execute the shutdown sequence as illustrated by process P23. When the shutdown sequence is completed, the slave ECUs 3 to 5 transmit a completion response to the master ECU 2 as illustrated by process P24.

The master ECU 2 that has received the completion response switches the relays 15, 16, and 17 from the on state to the off state as illustrated by process P25. The communication system 1 configured as described above includes the slave ECU 3 and the master ECU 2.

The master ECU 2 is configured to determine whether the slave ECU 3 is in a cutoff-allowable state (hereinafter, cutoff-allowable state) in which the relay 15 may be brought into the cutoff state by performing data communication with the slave ECU 3. Specifically, the master ECU 2 is configured to transmit a sleep notification indicating to transition to the sleep state to the slave ECU 3, transmit an acknowledgment response to the slave ECU 3, and determine that the slave ECU 3 is in the cutoff-allowable state when a completion response indicating that the shutdown sequence has been completed is received from the slave ECU 3 after transmitting the acknowledgment response.

The master ECU 2 is configured to bring the relay 15 into the cutoff state when it is determined that the slave ECU 3 is in the cutoff-allowable state. Such a communication system 1 can suppress the occurrence of a situation where the relay 15 remains in the conduction state even though the power supply to the slave ECU 3 can be cut off because the slave ECU 3 is transitioning to the sleep state. Therefore, the communication system 1 can improve the reliability of control for supplying power to the slave ECU 3.

In the embodiment described above, S510 to S530 correspond to the process as the state confirmation section, and S540 corresponds to the process as the power supply control section.

### Fourth Embodiment

Hereinafter, the fourth embodiment of the present disclosure will be described with reference to the drawings. In the fourth embodiment, components different from the third embodiment will be described. Common configurations are denoted by the same reference numerals.

The communication system 1 of the fourth embodiment is different from that of the third embodiment in that a request process is executed instead of the notification process, and the management process has been changed. Next, a procedure of the request process will be described. The request process is a process repeatedly executed during activation of the slave ECUs 3 to 5.

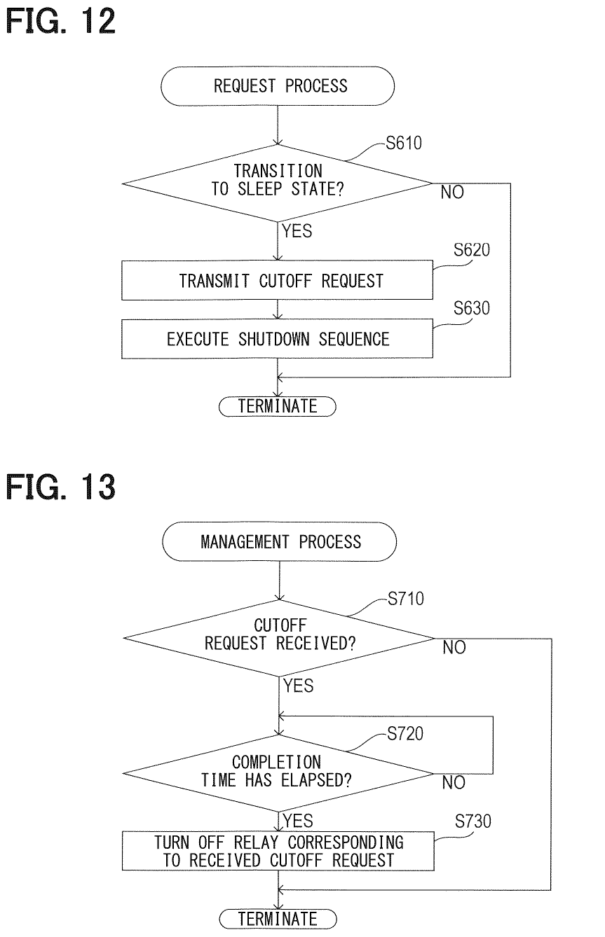

When the request process is executed, in S610, the CPU 41 of the control section 31 determines whether it is necessary to transition from the wake-up state to the sleep state as illustrated in FIG. 12. Here, if it is not necessary to transition to the sleep state, the request process is terminated.

On the other hand, if it is necessary to transition from the wake-up state to the sleep state, the CPU 41 transmits a cutoff request requesting to cut off the power supply to the master ECU 2 in S620. The cutoff request includes completion time information indicating a preset completion time as the time required to complete the shutdown sequence after starting it.

In S630, the CPU 41 executes the shutdown sequence and terminates the request process after the shutdown sequence is completed. Next, a procedure of the management process according to the fourth embodiment will be described. The management process of the fourth embodiment is a process repeatedly executed during activation of the master ECU 2.

When the management process of the fourth embodiment is executed, in S710, the CPU 21 of the control section 11 determines whether a cutoff request has been received from the slave ECUs 3 to 5 as illustrated in FIG. 13. Here, if the cutoff request has not been received, the CPU 21 terminates the management process.

On the other hand, if the cutoff request has been received, the CPU 21 determines whether the completion time indicated by the completion time information included in the received cutoff request has elapsed in S720. Here, if the completion time has not elapsed, the CPU 21 waits until the completion time elapses by repeating the process of S720.

When the completion time elapses, the CPU 21 switches the relay connected to the slave ECU that is the transmission source of the received cutoff request to the off state in S730 and terminates the management process.

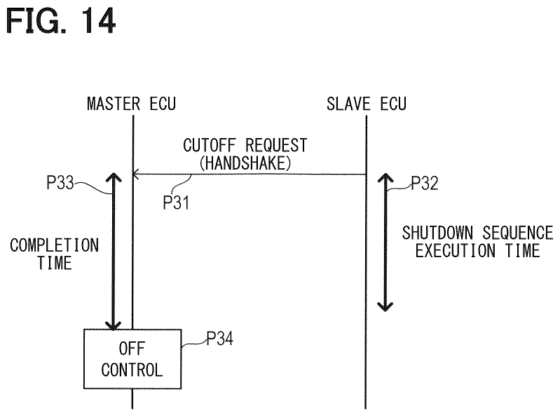

As illustrated in FIG. 14, after the handshake of the shutdown sequence is executed between the master ECU 2 and the slave ECUs 3 to 5, the relays 15, 16, and 17 are switched from the on state to the off state.

Specifically, as illustrated by process P31 in FIG. 14, the slave ECUs 3 to 5 transmit a cutoff request to the master ECU 2. The slave ECUs 3 to 5 that have transmitted the cutoff request execute the shutdown sequence as illustrated by process P32.

The master ECU 2 that has received the cutoff request waits until the completion time elapses as illustrated by process P33. When the completion time elapses, the master ECU 2 switches the relays 15, 16, and 17 from the on state to the off state as illustrated by process P34. The communication system 1 configured as described above includes the slave ECU 3 and the master ECU 2.

The master ECU 2 is configured to determine whether the slave ECU 3 is in a cutoff-allowable state (hereinafter, cutoff-allowable state) in which the relay 15 may be brought into the cutoff state by performing data communication with the slave ECU 3. Specifically, the master ECU 2 is configured to receive a cutoff request including completion time information indicating the time required to complete the shutdown sequence and requesting to switch the relay 15 to the cutoff state from the slave ECU 3, and determine that the slave ECU 3 is in the cutoff-allowable state when the completion time has elapsed after receiving the cutoff request.

The master ECU 2 is configured to bring the relay 15 into the cutoff state when it is determined that the slave ECU 3 is in the cutoff-allowable state. Such a communication system 1 can suppress the occurrence of a situation where the relay 15 remains in the conduction state even though the power supply to the slave ECU 3 can be cut off because the slave ECU 3 is transitioning to the sleep state. Therefore, the communication system 1 can improve the reliability of control for supplying power to the slave ECU 3.

In the embodiment described above, S710 to S720 correspond to the process as the state confirmation section, and S730 corresponds to the process as the power supply control section.

### Fifth Embodiment

Hereinafter, the fifth embodiment of the present disclosure will be described with reference to the drawings. In the fifth embodiment, components different from the first embodiment will be described. Common configurations are denoted by the same reference numerals.

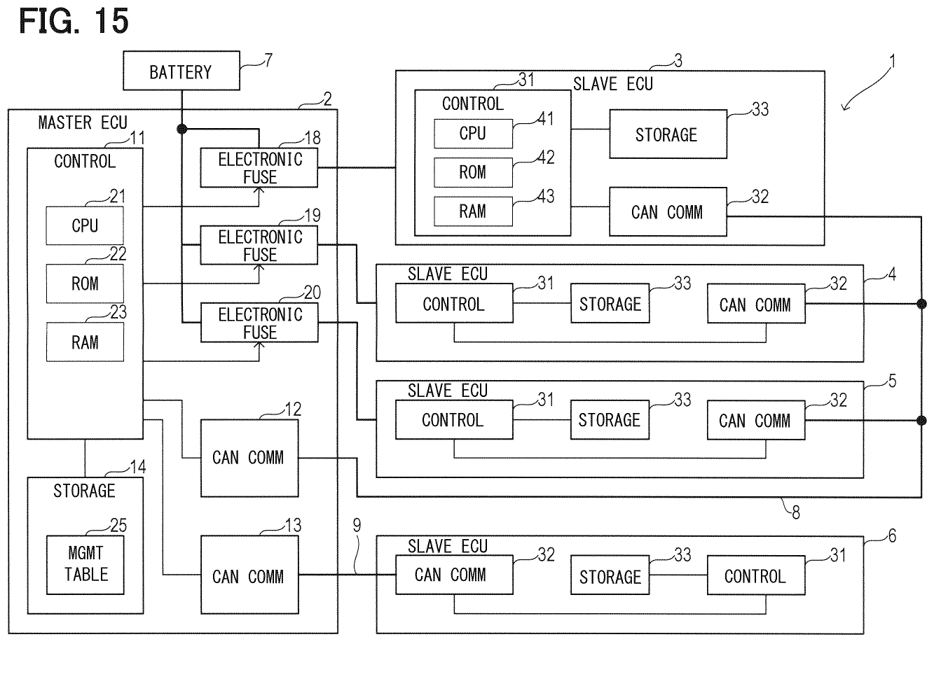

The communication system 1 of the fifth embodiment is different from that of the first embodiment in that electronic fuses 18, 19, and 20 are provided instead of the relays 15, 16, and 17 as illustrated in FIG. 15. The electronic fuse 18 is disposed on a power supply path between the battery 7 and the slave ECU 3. The electronic fuse 19 is disposed on a power supply path between the battery 7 and the slave ECU 4. The electronic fuse 20 is disposed on a power supply path between the battery 7 and the slave ECU 5.

The electronic fuses 18 to 20 include a switching element (for example, MOSFET) and a control circuit. The control circuit of the electronic fuses 18 to 20 is configured to cut off the power supply path by switching the switching element from the on state to the off state when the current value flowing through the power supply path exceeds a preset overcurrent determination value.

The control circuits of the electronic fuses 18 to 20 are configured to conduct or cut off the power supply path by switching the switching element to the on state or the off state in accordance with a command from the control section 11.

The control circuits of the electronic fuses 18 to 20 are configured to measure the current value flowing through the electronic fuses 18 to 20 and output current value information indicating the measured current value to the master ECU 2. The communication system 1 of the fifth embodiment is different from that of the first embodiment in that the management process has been changed and the slave ECUs 3 to 5 do not execute the response process.

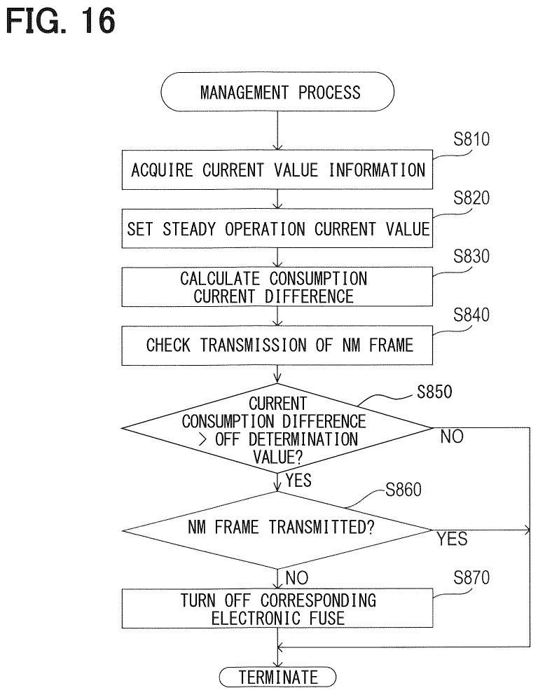

Next, a procedure of the management process according to the fifth embodiment will be described. The management process of the fifth embodiment is a process repeatedly executed during activation of the master ECU 2. When the management process of the fifth embodiment is executed, in S810, the CPU 21 of the control section 11 acquires current value information from the electronic fuses 18 to 20 as illustrated in FIG. 16.

In S820, the CPU 21 sets a current value (hereinafter, steady-state operation current value) consumed by the slave ECUs 3 to 5 during steady-state operation. The steady-state operation refers to the operation performed by the slave ECUs 3 to 5 in a steady state, which is the state after the startup process executed to activate the slave ECUs 3 to 5 is completed when the power supply from the battery 7 is started. Alternatively, the steady-state operation refers to the operation performed by the slave ECUs 3 to 5 in a steady state, which is the state after the startup process executed to activate the slave ECUs 3 to 5 is completed when transitioning from the sleep state to the wake-up state.

Specifically, the CPU 21 sets the average of a plurality of current values indicated by a plurality of current value information acquired within a preset steady-state operation determination time as the steady-state operation current value when the current value flowing through the electronic fuse is within a preset current value range as the current value during steady-state operation for the steady-state operation determination time. The steady-state operation current value of the slave ECUs 3, 4, and 5 is set based on the current value information acquired from the electronic fuses 18, 19, and 20, respectively.

In S830, the CPU 21 calculates a consumption current difference by subtracting the current value indicated by the current value information acquired in S810 from the steady-state operation current value set in S820 for each of the slave ECUs 3 to 5.

In S840, the CPU 21 confirms whether an NM frame instructing the activation of the slave ECUs 3 to 5 has been transmitted within a preset transmission determination time from the current time. The storage section 14 of the master ECU 2 stores an activation group table in which a correspondence relationship between an activation group and an ECU belonging to the activation group is set for each of a plurality of activation groups. For example, the activation group table is set such that the master ECU 2 and the slave ECUs 3 and 6 belong to the first communication group, and the master ECU 2 and the slave ECUs 4 and 5 belong to the second communication group.

Therefore, when the CPU 21 receives an NM frame, it specifies the activation group based on the activation information included in the NM frame, and further specifies the ECU belonging to the specified activation group by referring to the activation group table. Then, the CPU 21 determines that an NM frame instructing the activation of the slave ECUs 3 to 5 has been transmitted when the specified ECU is the slave ECUs 3 to 5.

In S850, the CPU 21 determines whether the consumption current difference calculated in S830 is greater than a preset off determination value for each of the slave ECUs 3 to 5. Here, if the consumption current difference is less than or equal to the off determination value for all the slave ECUs 3 to 5, the CPU 21 terminates the management process.

On the other hand, if the consumption current difference is greater than the off determination value for at least one of the slave ECUs 3 to 5, the CPU 21 determines whether an NM frame instructing the activation of the slave ECU with the consumption current difference greater than the off determination value has been transmitted based on the confirmation result in S840 in S860.

Here, if an NM frame instructing the activation of all the slave ECUs with the consumption current difference greater than the off determination value has been transmitted, the CPU 21 terminates the management process.

On the other hand, if there is a slave ECU with the consumption current difference greater than the off determination value and an NM frame instructing the activation has not been transmitted, the CPU 21 switches the electronic fuse connected to the slave ECU with the consumption current difference greater than the off determination value and the NM frame instructing the activation has not been transmitted to the off state in S870 and terminates the management process. For example, if the consumption current difference for the slave ECU 4 is greater than the off determination value and an NM frame instructing the activation of the slave ECU 4 has not been transmitted, the CPU 21 switches the electronic fuse 19 connected to the slave ECU 4 to the off state.

The communication system 1 configured as described above includes the slave ECU 3 and the master ECU 2. The slave ECU 3 receives power from the battery 7 via the electronic fuse 18 configured to switch between a conduction state in which the power supply path is conducted and a cutoff state in which the power supply path is cut off.

The master ECU 2 is data-communicably connected to the slave ECU 3, is configured to transmit and receive CAN frames, and is configured to control the operation of the electronic fuse 18. The master ECU 2 is configured to determine whether the slave ECU 3 is in a cutoff-allowable state (hereinafter, cutoff-allowable state) in which the relay 15 may be brought into the cutoff state. Specifically, the master ECU 2 is configured to calculate the difference between the steady-state operation current value, which is the current value consumed during steady-state operation of the slave ECU 3, and the current value consumed at the current time as the consumption current difference.

The master ECU 2 is configured to confirm whether an NM frame, which is a CAN frame including activation information indicating whether to activate the slave ECU 3, has been transmitted to the master ECU 2.

The master ECU 2 is configured to bring the electronic fuse 18 into the cutoff state when it is determined that the slave ECU 3 is in the cutoff-allowable state. Specifically, the master ECU 2 is configured to bring the electronic fuse 18 into the cutoff state when a preset cutoff determination condition indicating that the consumption current difference is large is satisfied and an NM frame instructing the activation of the slave ECU 3 has not been transmitted to the master ECU 2. The cutoff determination condition of the present embodiment is that the consumption current difference is greater than a preset off determination value.

Such a communication system 1 can suppress the occurrence of a situation where the relay 15 remains in the conduction state even though the power supply to the slave ECU 3 can be cut off because the slave ECU 3 is transitioning to the sleep state. Therefore, the communication system 1 can improve the reliability of control for supplying power to the slave ECU 3.

The master ECU 2 is configured to set the steady-state operation current value by measuring the current flowing through the power supply switching section during steady-state operation. This allows the communication system 1 to set the steady-state operation current value based on the actual current value consumed by the slave ECU 3 during steady-state operation.

In the embodiment described above, the electronic fuse 18 corresponds to the power supply switching section, S810 to S830 correspond to the process as the current difference calculation section, S840 corresponds to the process as the management frame confirmation section, and S850 to S870 correspond to the process as the power supply control section.

### Sixth Embodiment

Hereinafter, the sixth embodiment of the present disclosure will be described with reference to the drawings. In the sixth embodiment, components different from the first embodiment will be described. Common configurations are denoted by the same reference numerals.

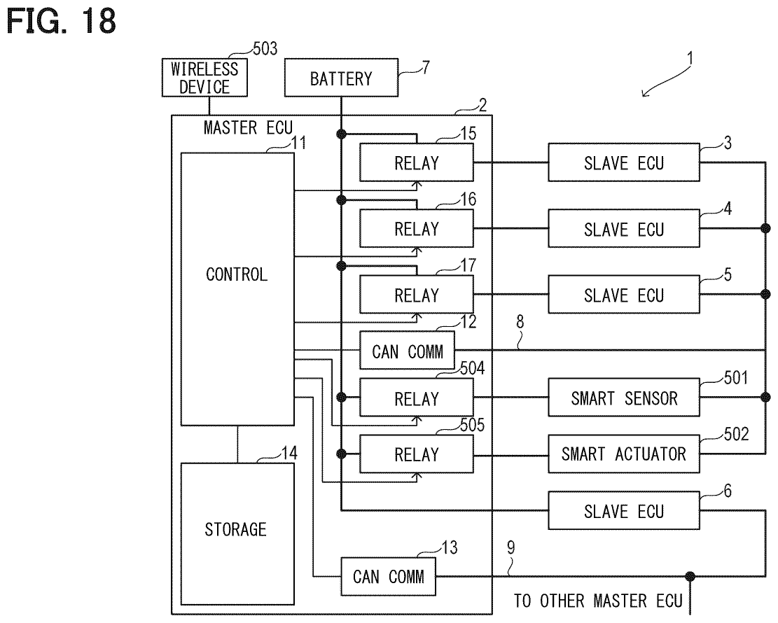

The communication system 1 of the sixth embodiment is different from that of the first embodiment in that a smart sensor 501, a smart actuator 502, a wireless device 503, and relays 504 and 505 are added as illustrated in FIG. 18.

The smart sensor 501 is a sensor with a communication function. The smart sensor 501 is connected to the communication bus 8. The smart actuator 502 is an actuator with a communication function. The smart actuator 502 is connected to the communication bus 8.

The wireless device 503 is a wireless communication device for performing wireless communication with an external communication device installed outside the vehicle. The wireless device 503 is, for example, a DCM. DCM stands for Data Communication Module.

The relay 504 is disposed on a power supply path between the battery 7 and the smart sensor 501. The relay 505 is disposed on a power supply path between the battery 7 and the smart actuator 502.

The relays 504 and 505 are configured to switch between a conduction state in which the power supply path is conducted and a cutoff state in which the power supply path is cut off in accordance with a command from the control section 11. Hereinafter, the master ECU 2, the slave ECUs 3 to 6, the smart sensor 501, and the smart actuator 502 are collectively referred to as nodes.

### (Premise)

The master ECU 2 and the slave ECU 6 are always powered from the battery 7 without passing through a relay and can switch to the wake-up state or the sleep state by themselves. Hereinafter, the master ECU 2 and the slave ECU 6 are also referred to as NM-equipped nodes. NM-equipped nodes are nodes having a function of generating NM frames.

The slave ECUs 3 to 5, the smart sensor 501, and the smart actuator 502 are powered through relays and cannot switch to the wake-up state or the sleep state by themselves. That is, they transition to the wake-up state when the relay is turned on and transition to the sleep state when the relay is turned off. Hereinafter, the slave ECU 3, the slave ECU 5, the smart sensor 501, and the smart actuator 502 are also referred to as NM-non-equipped nodes. The NM-non-equipped nodes are nodes that do not have a function of generating and interpreting NM frames.

The NM-non-equipped nodes include at least one of an actuator and a sensor in addition to an ECU having a control function. The power supply paths of the NM-non-equipped nodes are connected to the relays 15, 16, 17, 504, and 505 of the master ECU 2, respectively.

The NM-non-equipped nodes and the relays may be connected in a one-to-one manner, or a plurality of NM-non-equipped nodes belonging to the same cluster (that is, a group activated simultaneously) may be connected under one relay. The master ECU 2 and the NM-equipped nodes have CAN

communication sections and can transmit and receive NM frames. The NM-equipped nodes determine whether they are in the wake-up state or the sleep state based on the NM frames transmitted and received via the communication bus.

The master ECU 2 switches the relays 15, 16, 17, 504, and 505 connected to the NM-non-equipped nodes to the on state or the off state based on the NM frames transmitted and received via the communication bus. The payload (that is, the data area) of the NM frames transmitted and received by the master ECU 2 and the NM-equipped nodes includes information indicating which cluster to activate, stored in one or more bits.

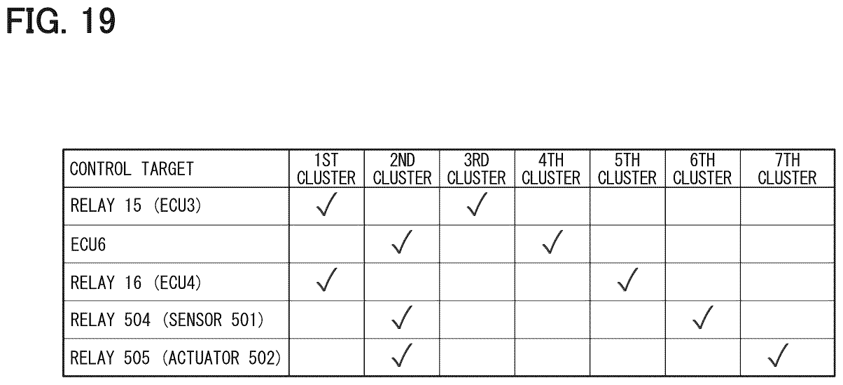

One or more master ECUs (that is, ECUs with built-in relays) are mounted on the vehicle. As illustrated in FIG. 19, one or more nodes belonging to each cluster are predetermined by the system developer. It is possible to assign a cluster to each node, but multiple nodes can be registered in one cluster. When the bit corresponding to each cluster is active (that is, bit=1), the cluster wakes up. In the case of the master ECU, waking up means turning the relay to the on state. Here, bit=1 indicates an active value, and bit=0 indicates an inactive value.

### First Activation Example

The first activation example is an operation example in which the slave ECU 3 is diagnosed for faults based on a request from the cloud.

First, a connection request is sent from the base station (that is, the cloud) to the vehicle's wireless device 503. Next, when the wireless device 503 determines that the connection is valid, it informs the master ECU 2 of the event received from the cloud. Next, the master ECU 2 determines the service as “fault diagnosis of the slave ECU 3” based on the event and generates an NM frame with the bit of the third cluster, to which only the slave ECU 3 belongs, set to active to activate the slave ECU 3.

Next, the master ECU 2 transmits the generated NM frame onto the communication buses 8 and 9. Since there are no NM-equipped nodes belonging to the third cluster on the communication buses 8 and 9, there is no change in the devices on the communication buses. Next, the master ECU 2 simultaneously executes the process based on the NM frame in the control section 11 as if it had received the NM frame with the bit of the third cluster set to active.

Next, the control section 11 of the master ECU 2 determines the wake-up instruction for the third cluster based on the NM frame, and since the relay 15 is included in the third cluster, it turns the relay 15 to the on state. When the relay 15 is turned on, power is supplied to the downstream slave ECU 3, which activates.

The master ECU 2 waits for the activation of the slave ECU 3, requests the diagnostic code from the slave ECU 3, and transmits the response result from the slave ECU 3 to the base station via the wireless device 503.

### Second Activation Example

The second activation example is an operation example in which the slave ECU 6 is diagnosed for faults based on a request from the cloud.

First, a connection request is sent from the base station (that is, the cloud) to the vehicle's wireless device 503. Next, when the wireless device 503 determines that the connection is valid, it informs the master ECU 2 of the event received from the cloud. Next, the master ECU 2 determines the service as “fault diagnosis of the slave ECU 6” based on the event and generates an NM frame with the bit of the fourth cluster, to which only the slave ECU 6 belongs, set to active to activate the slave ECU 6.

Next, the master ECU 2 transmits the generated NM frame onto the communication buses 8 and 9. Since the slave ECU 6, which belongs to the fourth cluster, is on the communication bus 9, the slave ECU 6 wakes up.

Next, the master ECU 2 simultaneously executes the process based on the NM frame in the control section 11 as if it had received the NM frame with the bit of the fourth cluster set to active. Next, even if the control section 11 of the master ECU 2 determines the wake-up instruction for the fourth cluster based on the NM frame, it ignores it because there is no corresponding relay in the fourth cluster.

When the slave ECU 6 wakes up, the master ECU 2 requests the diagnostic code from the slave ECU 6 via the communication bus and transmits the response result from the slave ECU 6 to the base station via the wireless device 503.

### Third Activation Example

The third activation example is an operation example in which the user activates the remote air conditioning using a smartphone. First, the user instructs the vehicle air conditioner to turn on from the smartphone.

When the wireless device 503 receives the instruction signal from the smartphone and determines that the instruction signal is valid, it informs the master ECU 2 of the event (that is, the instruction signal) received from the cloud. The master ECU 2 determines the “air conditioning service” based on the event and generates an NM frame with the second cluster, which is the air conditioning cluster, set to active.

The master ECU 2 periodically transmits the generated NM frame onto the communication buses 8 and 9 until an air conditioner stop instruction is issued. To maintain the active state, the NM frame must be transmitted periodically. Simultaneously, the control section 11 of the master ECU 2 executes the process based on the NM frame. When the NM frame with the second cluster set to active appears on the communication bus 9, the slave ECU 6 (that is, the air conditioner ECU) registered in the second cluster receives the NM frame and wakes up according to the received NM frame.

When the control section 11 of the master ECU 2 detects that the second cluster is active, it turns the relays 504 and 505 to the on state. When the relays 504 and 505 are turned on, power is supplied to the smart sensor 501 (that is, the temperature sensor) and the smart actuator 502 (that is, the compressor).

As a result, power supply to the air conditioner ECU, the smart sensor 501, and the smart actuator 502 starts, making it possible to turn on the vehicle air conditioner. When the user instructs the vehicle air conditioner to turn off from the smartphone, the master ECU 2 stops the periodic transmission of the NM frame.

When the NM frame is interrupted, the slave ECU 6 transitions to the sleep state, and the master ECU 2 turns off the relays 504 and 505. This stops the vehicle air conditioner.

### Fourth Activation Example

The fourth activation example is an operation example in which the vehicle air conditioner is activated from the slave ECU 6.

Since the slave ECU 6 is always supplied with power even when the vehicle is stopped, it can wake up by detecting the input of a signal indicating that the activation switch connected to the slave ECU 6 has been turned on, even while in the sleep state.

When the slave ECU 6 wakes up and confirms the input to be activated regarding the vehicle air conditioner, it generates an NM frame with the bit corresponding to the second cluster set to on. The slave ECU 6 transmits the generated NM frame via the CAN communication section 32. When the master ECU 2 receives this NM frame, it turns the relays 504 and 505 belonging to the second cluster to the on state.

When the activation switch of the vehicle air conditioner is turned off, the slave ECU 6 stops transmitting the NM frame and transitions to the sleep state after a while. When the NM frame is interrupted, the master ECU 2 turns off the relays 504 and 505 after a while and ends the control.

If the master ECU 2 determines that it is necessary to continue control even after the transmission of the NM frame is stopped, the master ECU 2 transmits an NM frame with the bit corresponding to the second cluster set to on. This allows the slave ECU 6 and the relays 504 and 505 to maintain the activation state until the transmission of the NM frame generated by the master ECU 2 is stopped.

### (Power Supply Shutdown Process Extension)

NM-equipped nodes are supplied with power without passing through a relay and can execute the termination process to transition to a low power consumption state by themselves. However, NM-non-equipped nodes cannot execute the termination process if the power supply is suddenly cut off by turning off the relay. The termination process includes, for example, saving operation logs, saving diagnostic data, saving learning results, and setting input/output devices to the initial position for the next activation.

The communication system 1 of the third embodiment can perform the following first, second, third, and fourth measures to secure time for the termination process.

### (First Measure)

The master ECU 2, which controls the relays 15, 16, 17, 504, and 505, notifies the subordinate nodes (that is, the slave ECUs 3, 4, 5, the smart sensor 501, and the smart actuator 502) of a relay-off advance message via the CAN communication section 12 before executing the relay-off. The master ECU 2 also stops transmitting non-emergency CAN communication. The advance message may have a predetermined CANID and data pattern. The advance message may be referred to as a pre-notification message.

The master ECU 2 manages the time required for the termination process of the subordinate nodes. After transmitting the above advance message, the master ECU 2 measures the elapsed time and turns off the relays 15, 16, 17, 504, and 505 when the time required for the termination process has elapsed. When the NM-non-equipped nodes receive the relay-off advance message, they stop communication, execute the termination process, and wait for the power supply to be cut off.

### (Second Measure)

The master ECU 2 notifies the subordinate nodes of a relay-off advance message via the CAN communication section 12 before executing the relay-off. The master ECU 2 also stops transmitting non-emergency CAN communication. The advance message may have a predetermined CANID and data pattern.

The master ECU 2 manages the time required for the termination process of the subordinate nodes for each node. After transmitting the above advance message, the master ECU 2 measures the elapsed time and sequentially turns off the relays corresponding to the nodes when the time required for the termination process has elapsed. When the NM-non-equipped nodes receive the relay-off advance message, they stop communication, execute the termination process, and wait for the power supply to be cut off.

### (Third Measure)

The master ECU 2 and the NM-equipped nodes can synchronize the sleep timing by mutually transmitting and receiving NM frames.

When the sleep condition is satisfied with the end of the provided service, the master ECU 2 stops communication, including NM frames. Then, the master ECU 2 turns off the relays after the time required for the NM-non-equipped nodes to determine the interruption of the NM frame (for example, 3 seconds) and the time required for the termination process of the NM-non-equipped nodes (for example, 2 seconds) have elapsed (for example, 5 seconds). The NM-non-equipped nodes monitor the NM frames on the communication bus 8 and, when the interruption of the NM frame is detected for a certain period (for example, 3 seconds), stop transmitting from their nodes to the communication bus 8, execute the termination process, and wait for the power supply to be cut off.

If the NM-non-equipped nodes cannot complete the termination process within the predetermined required time, they can send a predetermined command to the master ECU 2 to request an extension of the time until the relay is turned off.

### (Fourth Measure)

The master ECU 2 and the NM-equipped nodes can synchronize the sleep timing by mutually transmitting and receiving NM frames.

When the sleep condition of a predetermined cluster is satisfied with the end of the provided service, the master ECU 2 sets the bit corresponding to the cluster in the NM frame to 0 (that is, off value). Then, after a certain period (for example, 3 seconds) has elapsed since all the bits have become 0, the master ECU 2 stops communication, including NM frames. After that, the master ECU 2 turns off the relays after the time required for the termination process of the NM-non-equipped nodes (for example, 2 seconds) has elapsed. Here, the NM-non-equipped nodes have the function of receiving and interpreting NM frames. The NM-non-equipped nodes always monitor the NM frames transmitted by the master ECU 2 and start the termination process when all the bits of the cluster containing the upstream relay supplying power to their nodes are 0. This allows the NM-non-equipped nodes to complete the termination process before the relay supplying power to their nodes is turned off. The NM-equipped nodes sleep according to the NM frames transmitted and received between them and the master ECU 2.

If the NM-non-equipped nodes cannot complete the termination process within the predetermined required time, they can send a predetermined command to the master ECU 2 to request an extension of the time before the relay is turned off. In this case, the master ECU 2 waits to turn off the relay while receiving the extension request from the NM-non-equipped nodes.

### Seventh Embodiment

Hereinafter, the seventh embodiment of the present disclosure will be described with reference to the drawings. In the seventh embodiment, components different from the first embodiment will be described.

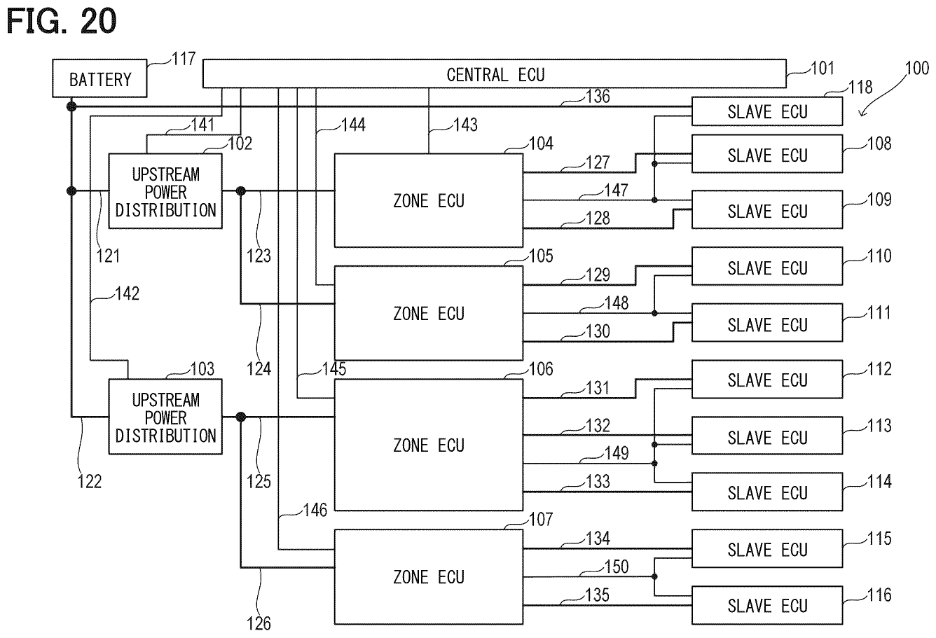

As illustrated in FIG. 20, the communication system 100 of the seventh embodiment includes a central ECU 101, upstream power distribution sections 102 and 103, zone ECUs 104, 105, 106, and 107, slave ECUs 108, 109, 110, 111, 112, 113, 114, 115, and 116, a battery 117, and a slave ECU 118. Hereinafter, the central ECU 101, the zone ECUs 104 to 107, and the slave ECUs 108 to 116 and 118 are collectively referred to as nodes. Here, the zone ECU may be an ECU that bundles slave ECUs located in a predetermined area in the vehicle or an ECU that bundles slave ECUs belonging to a predetermined domain.

The battery 117 supplies power to each section of the vehicle with a direct-current battery voltage (for example, 12 V). The central ECU 101, the upstream power distribution sections 102 and 103, the zone ECUs 104 to 107, and the slave ECUs 108 to 116 and 118 operate by receiving a power supply from the battery 117.

The upstream power distribution section 102 receives power from the battery 117 via a power supply path 121 between the battery 7 and the upstream power distribution section 102. The upstream power distribution section 103 receives power from the battery 117 via a power supply path 122 between the battery 7 and the upstream power distribution section 103.

The zone ECUs 104 and 105 receive power from the battery 117 via power supply paths 123 and 124 between the upstream power distribution section 102 and the zone ECUs 104 and 105, respectively.

The zone ECUs 106 and 107 receive power from the battery 117 via power supply paths 125 and 126 between the upstream power distribution section 103 and the zone ECUs 106 and 107, respectively.

The slave ECUs 108 and 109 receive power from the battery 117 via power supply paths 127 and 128 between the zone ECU 104 and the slave ECUs 108 and 109, respectively.

The slave ECUs 110 and 111 receive power from the battery 117 via power supply paths 129 and 130 between the zone ECU 105 and the slave ECUs 110 and 111, respectively.

The slave ECUs 112, 113, and 114 receive power from the battery 117 via power supply paths 131, 132, and 133 between the zone ECU 106 and the slave ECUs 112, 113, and 114, respectively.

The slave ECUs 115 and 116 receive power from the battery 117 via power supply paths 134 and 135 between the zone ECU 107 and the slave ECUs 115 and 116, respectively.

The slave ECU 118 receives power from the battery 117 via a power supply path 136. The central ECU 101 and the upstream power distribution section 102 are data-communicably connected to each other via a communication line 141.

The central ECU 101 and the upstream power distribution section 103 are data-communicably connected to each other via a communication line 142. The central ECU 101 and the zone ECUs 104, 105, 106, and 107 are data-communicably connected to each other via communication lines 143, 144, 145, and 146, respectively.

The zone ECU 104 and the slave ECUs 108, 109, and 118 are data-communicably connected to each other via a communication bus 147. The zone ECU 105 and the slave ECUs 110 and 111 are data-communicably connected to each other via a communication bus 148.

The zone ECU 106 and the slave ECUs 112, 113, and 114 are data-communicably connected to each other via a communication bus 149. The zone ECU 107 and the slave ECUs 115 and 116 are data-communicably connected to each other via a communication bus 150.

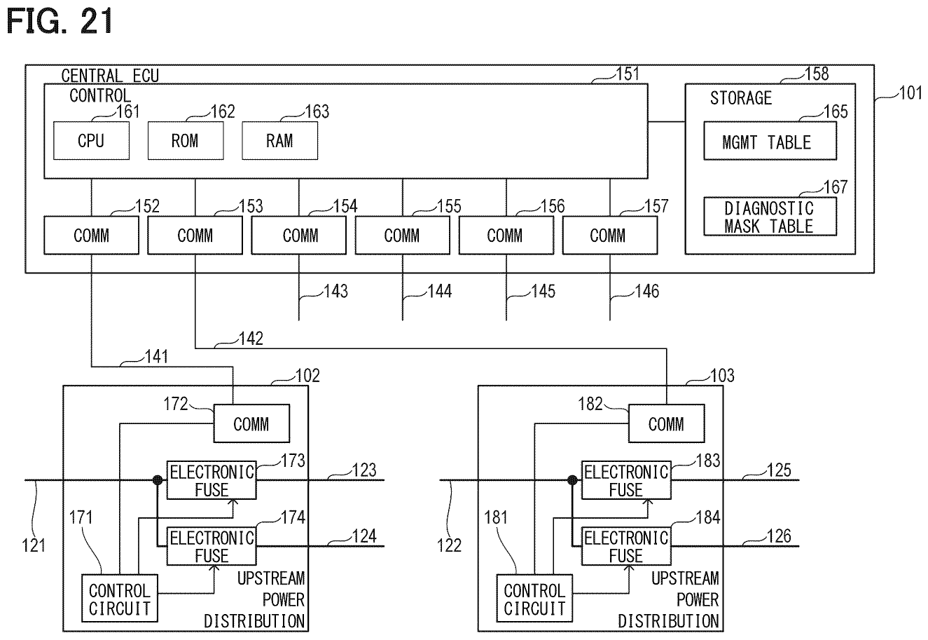

As illustrated in FIG. 21, the central ECU 101 includes a control section 151, communication sections 152, 153, 154, 155, 156, and 157, and a storage section 158. The control section 151 is an electronic control device mainly including a microcomputer including a CPU 161, a ROM 162, a RAM 163, and the like. Various functions of the microcomputer are implemented by the CPU 161 executing a program stored in a non-transitory tangible storage medium. In this example, the ROM 162 corresponds to a non-transitory tangible storage medium storing a program. Further, by executing this program, a method corresponding to the program is executed. Some or all of the functions executed by the CPU 161 may be configured as hardware by one or a plurality of ICs or the like. Furthermore, the number of microcomputers constituting the control section 151 may be one or more.

The communication section 152 performs communication with the upstream power distribution section 102 connected to the communication line 141 by transmitting and receiving a communication frame based on, for example, the Ethernet communication protocol. Ethernet is a registered trademark.

The communication section 153 performs communication with the upstream power distribution section 103 connected to the communication line 142 by transmitting and receiving a communication frame based on, for example, the Ethernet communication protocol. The communication section 154 performs communication with the zone ECU 104 connected to the communication line 143 by transmitting and receiving a communication frame based on, for example, the Ethernet communication protocol.

The communication section 155 performs communication with the zone ECU 105 connected to the communication line 144 by transmitting and receiving a communication frame based on, for example, the Ethernet communication protocol. The communication section 156 performs communication with the zone ECU 106 connected to the communication line 145 by transmitting and receiving a communication frame based on, for example, the Ethernet communication protocol.

The communication section 157 performs communication with the zone ECU 107 connected to the communication line 146 by transmitting and receiving a communication frame based on, for example, the Ethernet communication protocol. The storage section 158 is a storage device for storing various pieces of data. The storage section 158 stores a management table 165 and a diagnostic mask table 167 to be described later.

The upstream power distribution section 102 includes a control circuit 171, a communication section 172, and electronic fuses 173 and 174. The control circuit 171 controls switching the electronic fuses 173 and 174 between the on state and the off state based on instructions acquired from the central ECU 101 via the communication section 172.

The communication section 172 performs communication with the central ECU 101 connected to the communication line 141 by transmitting and receiving a communication frame based on, for example, the Ethernet communication protocol. The electronic fuse 173 is disposed between the power supply path 121 and the power supply path 123. The electronic fuse 174 is disposed between the power supply path 121 and the power supply path 124.

The upstream power distribution section 103 includes a control circuit 181, a communication section 182, and electronic fuses 183 and 184. The control circuit 181 controls switching the electronic fuses 183 and 184 between the on state and the off state based on instructions acquired from the central ECU 101 via the communication section 182.

The communication section 182 performs communication with the central ECU 101 connected to the communication line 142 by transmitting and receiving a communication frame based on, for example, the Ethernet communication protocol. The electronic fuse 183 is disposed between the power supply path 122 and the power supply path 125. The electronic fuse 184 is disposed between the power supply path 122 and the power supply path 126.

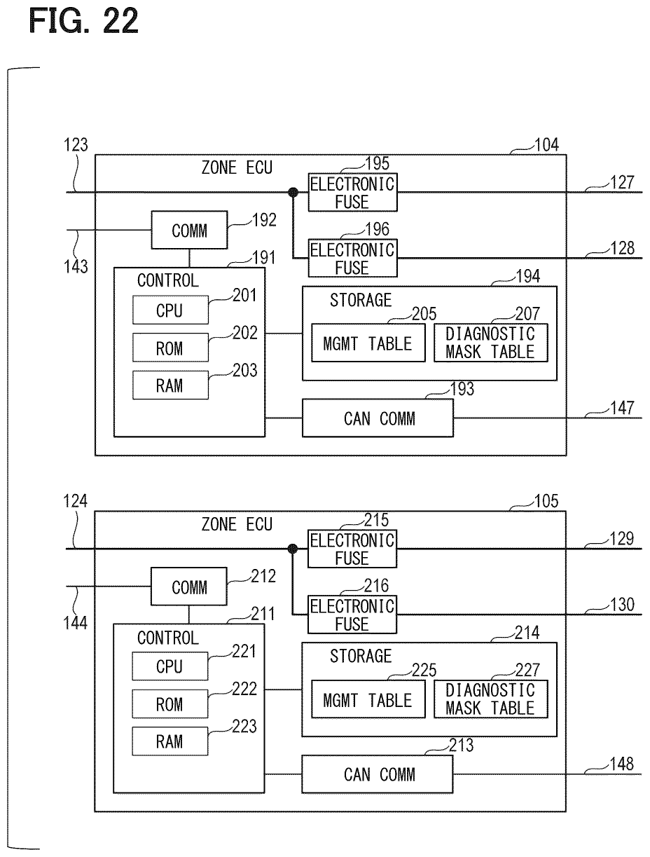

As illustrated in FIG. 22, the zone ECU 104 includes a control section 191, a communication section 192, a CAN communication section 193, a storage section 194, and electronic fuses 195 and 196. The control section 191 is an electronic control device mainly including a microcomputer including a CPU 201, a ROM 202, a RAM 203, and the like. Various functions of the microcomputer are implemented by the CPU 201 executing a program stored in a non-transitory tangible storage medium. In this example, the ROM 202 corresponds to a non-transitory tangible storage medium storing a program. Further, by executing this program, a method corresponding to the program is executed. Some or all of the functions executed by the CPU 201 may be configured as hardware by one or a plurality of ICs or the like. Furthermore, the number of microcomputers constituting the control section 191 may be one or more.

The communication section 192 performs communication with the central ECU 101 connected to the communication line 143 by transmitting and receiving a communication frame based on, for example, the Ethernet communication protocol. The CAN communication section 193 performs communication with the slave ECUs 108 and 109 connected to the communication bus 147 by transmitting and receiving a communication frame based on the CAN communication protocol.

The storage section 194 is a storage device for storing various pieces of data. The storage section 194 stores a management table 205 and a diagnostic mask table 207 to be described later. The electronic fuse 195 is disposed between the power supply path 123 and the power supply path 127. The electronic fuse 196 is disposed between the power supply path 123 and the power supply path 128.

The zone ECU 105 includes a control section 211, a communication section 212, a CAN communication section 213, a storage section 214, and electronic fuses 215 and 216. The control section 211 is an electronic control device mainly including a microcomputer including a CPU 221, a ROM 222, a RAM 223, and the like. Various functions of the microcomputer are implemented by the CPU 221 executing a program stored in a non-transitory tangible storage medium. In this example, the ROM 222 corresponds to a non-transitory tangible storage medium storing a program. Further, by executing this program, a method corresponding to the program is executed. Some or all of the functions executed by the CPU 221 may be configured as hardware by one or a plurality of ICs or the like. Furthermore, the number of microcomputers constituting the control section 211 may be one or more.

The communication section 212 performs communication with the central ECU 101 connected to the communication line 144 by transmitting and receiving a communication frame based on, for example, the Ethernet communication protocol. The CAN communication section 213 performs communication with the slave ECUs 110 and 111 connected to the communication bus 148 by transmitting and receiving a communication frame based on the CAN communication protocol.

The storage section 214 is a storage device for storing various pieces of data. The storage section 214 stores a management table 225 and a diagnostic mask table 227 to be described later. The electronic fuse 215 is disposed between the power supply path 124 and the power supply path 129. The electronic fuse 216 is disposed between the power supply path 124 and the power supply path 130.

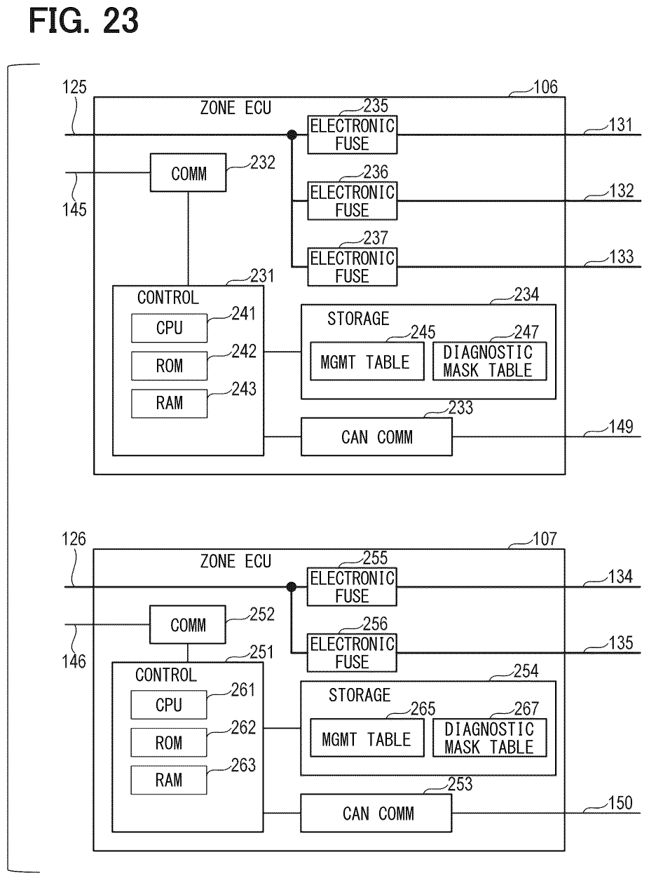

As illustrated in FIG. 23, the zone ECU 106 includes a control section 231, a communication section 232, a CAN communication section 233, a storage section 234, and electronic fuses 235, 236, and 237. The control section 231 is an electronic control device mainly including a microcomputer including a CPU 241, a ROM 242, a RAM 243, and the like. Various functions of the microcomputer are implemented by the CPU 241 executing a program stored in a non-transitory tangible storage medium. In this example, the ROM 242 corresponds to a non-transitory tangible storage medium storing a program. Further, by executing this program, a method corresponding to the program is executed. Some or all of the functions executed by the CPU 241 may be configured as hardware by one or a plurality of ICs or the like. Furthermore, the number of microcomputers constituting the control section 231 may be one or more.

The communication section 232 performs communication with the central ECU 101 connected to the communication line 145 by transmitting and receiving a communication frame based on, for example, the Ethernet communication protocol. The CAN communication section 233 performs communication with the slave ECUs 112, 113, and 114 connected to the communication bus 149 by transmitting and receiving a communication frame based on the CAN communication protocol.

The storage section 234 is a storage device for storing various pieces of data. The storage section 234 stores a management table 245 and a diagnostic mask table 247 to be described later. The electronic fuse 235 is disposed between the power supply path 125 and the power supply path 131. The electronic fuse 236 is disposed between the power supply path 125 and the power supply path 132. The electronic fuse 237 is disposed between the power supply path 125 and the power supply path 133.

The zone ECU 107 includes a control section 251, a communication section 252, a CAN communication section 253, a storage section 254, and electronic fuses 255 and 256. The control section 251 is an electronic control device mainly including a microcomputer including a CPU 261, a ROM 262, a RAM 263, and the like. Various functions of the microcomputer are implemented by the CPU 261 executing a program stored in a non-transitory tangible storage medium. In this example, the ROM 262 corresponds to a non-transitory tangible storage medium storing a program. Further, by executing this program, a method corresponding to the program is executed. Some or all of the functions executed by the CPU 261 may be configured as hardware by one or a plurality of ICs or the like. Furthermore, the number of microcomputers constituting the control section 251 may be one or more.

The communication section 252 performs communication with the central ECU 101 connected to the communication line 146 by transmitting and receiving a communication frame based on, for example, the Ethernet communication protocol. The CAN communication section 253 performs communication with the slave ECUs 115 and 116 connected to the communication bus 150 by transmitting and receiving a communication frame based on the CAN communication protocol.

The storage section 254 is a storage device for storing various pieces of data. The storage section 254 stores a management table 265 and a diagnostic mask table 267 to be described later. The electronic fuse 255 is disposed between the power supply path 126 and the power supply path 134. The electronic fuse 256 is disposed between the power supply path 126 and the power supply path 135.

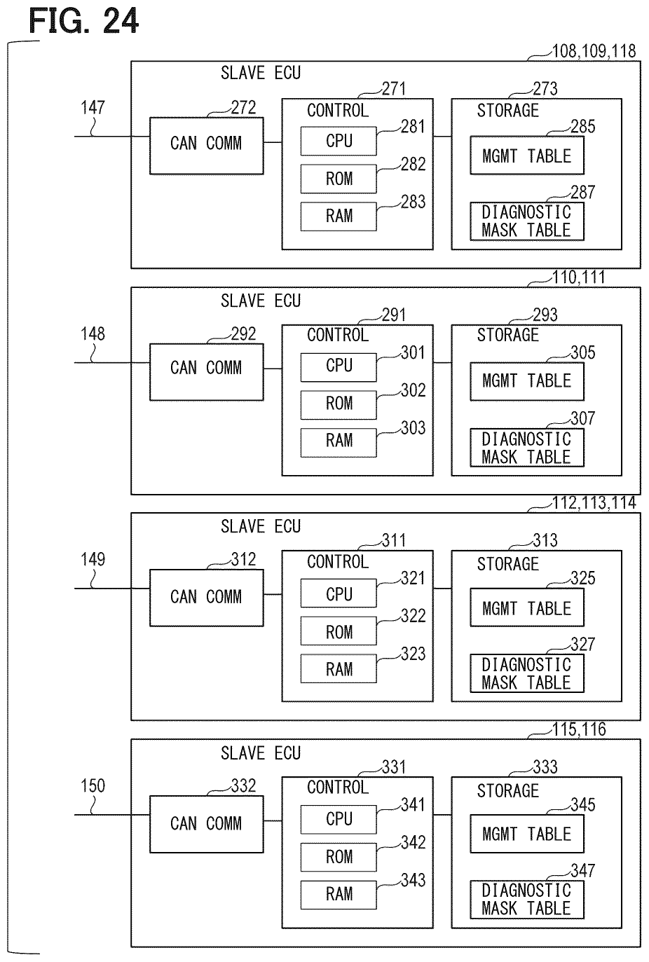

As illustrated in FIG. 24, the slave ECUs 108, 109, and 118 include a control section 271, a CAN communication section 272, and a storage section 273. The control section 271 is an electronic control device mainly including a microcomputer including a CPU 281, a ROM 282, a RAM 283, and the like. Various functions of the microcomputer are implemented by the CPU 281 executing a program stored in a non-transitory tangible storage medium. In this example, the ROM 282 corresponds to a non-transitory tangible storage medium storing a program. Further, by executing this program, a method corresponding to the program is executed. Some or all of the functions executed by the CPU 281 may be configured as hardware by one or a plurality of ICs or the like. Furthermore, the number of microcomputers constituting the control section 271 may be one or more.

The CAN communication section 272 performs communication with the zone ECU 104 connected to the communication bus 147 based on the CAN communication protocol. The storage section 273 is a storage device for storing various pieces of data. The storage section 273 stores a management table 285 and a diagnostic mask table 287 to be described later.

The slave ECUs 110 and 111 include a control section 291, a CAN communication section 292, and a storage section 293. The control section 291 is an electronic control device mainly including a microcomputer including a CPU 301, a ROM 302, a RAM 303, and the like. Various functions of the microcomputer are implemented by the CPU 301 executing a program stored in a non-transitory tangible storage medium. In this example, the ROM 302 corresponds to a non-transitory tangible storage medium storing a program. Further, by executing this program, a method corresponding to the program is executed. Some or all of the functions executed by the CPU 301 may be configured as hardware by one or a plurality of ICs or the like. Furthermore, the number of microcomputers constituting the control section 291 may be one or more.

The CAN communication section 292 performs communication with the zone ECU 105 connected to the communication bus 148 based on the CAN communication protocol. The storage section 293 is a storage device for storing various pieces of data. The storage section 293 stores a management table 305 and a diagnostic mask table 307 to be described later.

The slave ECUs 112, 113, and 114 include a control section 311, a CAN communication section 312, and a storage section 313. The control section 311 is an electronic control device mainly including a microcomputer including a CPU 321, a ROM 322, a RAM 323, and the like. Various functions of the microcomputer are implemented by the CPU 321 executing a program stored in a non-transitory tangible storage medium. In this example, the ROM 322 corresponds to a non-transitory tangible storage medium storing a program. Further, by executing this program, a method corresponding to the program is executed. Some or all of the functions executed by the CPU 321 may be configured as hardware by one or a plurality of ICs or the like. Furthermore, the number of microcomputers constituting the control section 311 may be one or more.

The CAN communication section 312 performs communication with the zone ECU 106 connected to the communication bus 149 based on the CAN communication protocol. The storage section 313 is a storage device for storing various pieces of data. The storage section 313 stores a management table 325 and a diagnostic mask table 327 to be described later.

The slave ECUs 115 and 116 include a control section 331, a CAN communication section 332, and a storage section 333. The control section 331 is an electronic control device mainly including a microcomputer including a CPU 341, a ROM 342, a RAM 343, and the like. Various functions of the microcomputer are implemented by the CPU 341 executing a program stored in a non-transitory tangible storage medium. In this example, the ROM 342 corresponds to a non-transitory tangible storage medium storing a program. Further, by executing this program, a method corresponding to the program is executed. Some or all of the functions executed by the CPU 341 may be configured as hardware by one or a plurality of ICs or the like. Furthermore, the number of microcomputers constituting the control section 331 may be one or more.

The CAN communication section 332 performs communication with the zone ECU 107 connected to the communication bus 150 based on the CAN communication protocol. The storage section 333 is a storage device for storing various pieces of data. The storage section 333 stores a management table 345 and a diagnostic mask table 347 to be described later.

The management tables 165, 205, 225, 245, 265, 285, 305, 325, and 345 set the correspondence relationship between services and switching information and activation information for each of a plurality of services provided to the occupants of the vehicle using the central ECU 101, the zone ECUs 104 to 107, and the slave ECUs 108 to 116 and 118.

The switching information indicates whether to turn on the electronic fuses 173, 174, 183, 184, 195, 196, 215, 216, 235, 236, 237, 255, and 256. The activation information indicates whether to bring the slave ECU 118 into the wake-up state.

The management tables 165, 205, 225, 245, 265, 285, 305, 325, and 345 may not store the switching information and activation information for services that the device itself cannot detect the establishment of the service start condition.

The diagnostic mask tables 167, 207, 227, 247, 267, 287, 307, 327, and 347 set the correspondence relationship between the slave ECUs (hereinafter, cutoff ECUs) whose power supply is cut off via the electronic fuses and the slave ECUs (hereinafter, sleep ECUs) that transition to the sleep state, and the CAN frame IDs (hereinafter, non-receiving frame IDs) that are not received for each service.

Therefore, when the central ECU 101, the zone ECUs 104 to 107, and the slave ECUs 108 to 116 and 118 detect that the service start condition is satisfied, they extract the switching information and activation information corresponding to the corresponding service from the management tables 165, 205, 225, 245, 265, 285, 305, 325, and 345, generate an NM frame including the extracted switching information and activation information, and transmit it. Furthermore, the central ECU 101, the zone ECUs 104 to 107, and the slave ECUs 108 to 116 and 118 extract the combination of the cutoff ECUs or sleep ECUs corresponding to the corresponding service and the non-receiving frame IDs from the diagnostic mask tables 167, 207, 227, 247, 267, 287, 307, 327, and 347, and transmit the extracted combination as diagnostic mask information.

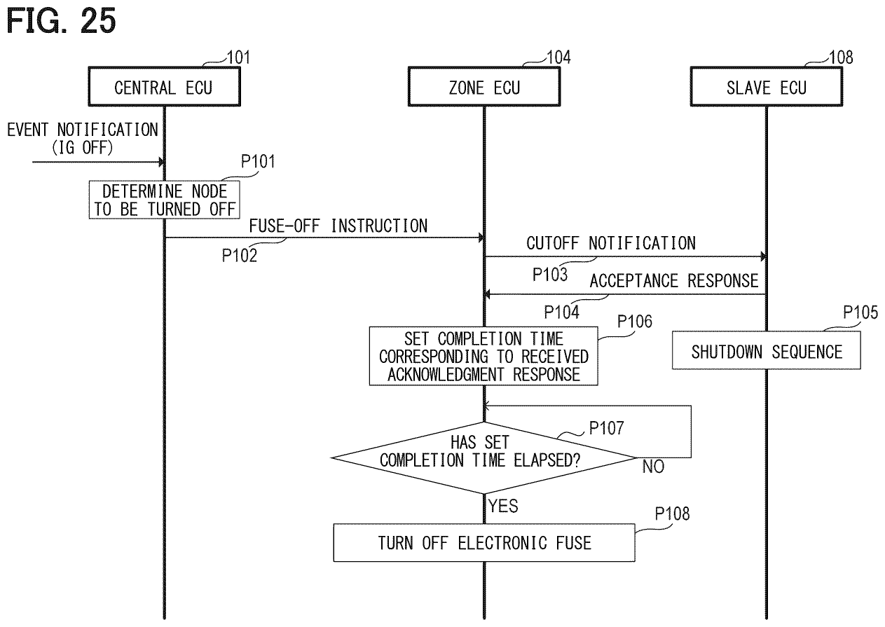

The form in which the zone ECU 104 executes the handshake will be described with reference to FIG. 25. When the central ECU 101 receives an event notification (for example, IG off), it determines the node to be turned off (for example, the slave ECU 108) as illustrated by process P101 in FIG. 25.

The central ECU 101 transmits a fuse-off instruction to turn off the electronic fuse 195 to the zone ECU 104 in process P102. When the zone ECU 104 receives the fuse-off instruction, it transmits a cutoff notification to the subordinate slave ECU 108 in process P103.

When the slave ECU 108 receives the cutoff notification, it transmits an acknowledgment response to the zone ECU 104 as illustrated by process P104. The slave ECU 108 that has transmitted the acknowledgment response executes the shutdown sequence as illustrated by process P105.

The zone ECU 104 that has transmitted the acknowledgment response sets the completion time corresponding to the received acknowledgment response as the waiting time in process P106. The zone ECU 104 waits until the completion time elapses in process P107. When the completion time elapses, the zone ECU 104 switches the electronic fuse 195 from the on state to the off state as illustrated by process P108.

In the communication system 100 configured as described above, when the zone ECU 104 receives a fuse-off instruction to turn off the electronic fuse 195 from the central ECU 101, it transmits a cutoff notification to the slave ECU 108. After transmitting the cutoff notification, when the zone ECU 104 receives an acknowledgment response including completion time information indicating the time required to complete the shutdown sequence from the slave ECU 108, it determines that the slave ECU 108 is in a cutoff-allowable state when the completion time has elapsed after receiving the acknowledgment response.

Such a communication system 100 can suppress the occurrence of a situation where the electronic fuse 195 is switched from the conduction state to the cutoff state even though the power supply to the slave ECU 108 should not be cut off because the shutdown sequence has not been completed. Therefore, the communication system 1 can improve the reliability of control for supplying power to the slave ECU 108.

In the embodiment described above, the slave ECU 108 corresponds to the first control device, the central ECU 101 and the zone ECU 104 correspond to the second control device, the electronic fuse 195 corresponds to the power supply switching section, and the battery 117 corresponds to the power source.

### Eighth Embodiment

Hereinafter, the eighth embodiment of the present disclosure will be described with reference to the drawings. In the eighth embodiment, components different from the seventh embodiment will be described.

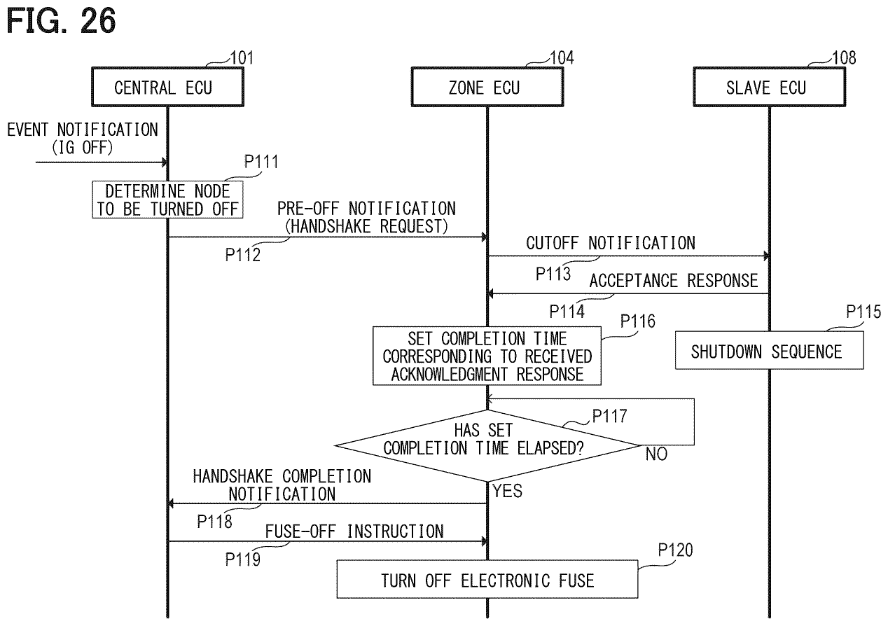

The form in which the central ECU 101 requests a handshake from the zone ECU 104 will be described with reference to FIG. 26. When the central ECU 101 receives an event notification (for example, IG off), it determines the node to be turned off (for example, the slave ECU 108) as illustrated by process P111 in FIG. 26.

The central ECU 101 transmits a pre-off notification to turn off the electronic fuse 195 to the zone ECU 104 in process P112. The pre-off notification corresponds to the handshake request.

When the zone ECU 104 receives the pre-off notification, it transmits a cutoff notification to the subordinate slave ECU 108 in process P113. When the slave ECU 108 receives the cutoff notification, it transmits an acknowledgment response to the zone ECU 104 as illustrated by process P114.

The slave ECU 108 that has transmitted the acknowledgment response executes the shutdown sequence as illustrated by process P115. The zone ECU 104 that has transmitted the acknowledgment response sets the completion time corresponding to the received acknowledgment response as the waiting time in process P116.

The zone ECU 104 waits until the completion time elapses in process P117. When the completion time elapses, the zone ECU 104 transmits a handshake completion notification to the central ECU 101 as illustrated by process P118.

When the central ECU 101 receives the handshake completion notification, it transmits a fuse-off instruction to turn off the electronic fuse 195 to the zone ECU 104 in process P119.

When the zone ECU 104 receives the fuse-off instruction, it switches the electronic fuse 195 from the on state to the off state as illustrated by process P120. In the communication system 100 configured as described above, when the zone ECU 104 receives a pre-off notification to turn off the electronic fuse 195 from the central ECU 101, it transmits a cutoff notification to the slave ECU 108. After transmitting the cutoff notification, when the zone ECU 104 receives an acknowledgment response including completion time information indicating the time required to complete the shutdown sequence from the slave ECU 108, it transmits a handshake completion notification to the central ECU 101 when the completion time has elapsed after receiving the acknowledgment response. After transmitting the handshake completion notification, when the zone ECU 104 receives a fuse-off instruction to turn off the electronic fuse 195 from the central ECU 101, it determines that the slave ECU 108 is in a cutoff-allowable state.

Such a communication system 100 can suppress the occurrence of a situation where the electronic fuse 195 is switched from the conduction state to the cutoff state even though the power supply to the slave ECU 108 should not be cut off because the shutdown sequence has not been completed. Therefore, the communication system 1 can improve the reliability of control for supplying power to the slave ECU 108.

In the embodiment described above, the slave ECU 108 corresponds to the first control device, the central ECU 101 and the zone ECU 104 correspond to the second control device, and the electronic fuse 195 corresponds to the power supply switching section. The slave ECU 108 also corresponds to the slave control device, the zone ECU 104 corresponds to the zone control device, and the central ECU 101 corresponds to the central control device.

Furthermore, the pre-off notification corresponds to the pre-cutoff notification, and the fuse-off instruction corresponds to the power supply cutoff instruction.

### Ninth Embodiment

Hereinafter, the ninth embodiment of the present disclosure will be described with reference to the drawings. In the ninth embodiment, components different from the seventh embodiment will be described.

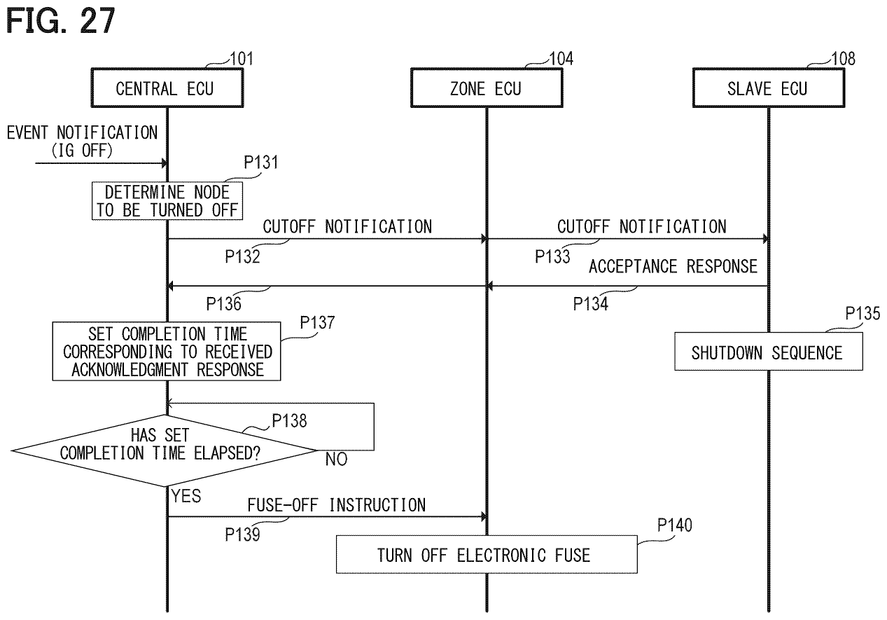

The form in which the central ECU 101 executes the handshake will be described with reference to FIG. 27. When the central ECU 101 receives an event notification (for example, IG off), it determines the node to be turned off (for example, the slave ECU 108) as illustrated by process P131 in FIG. 27.

The central ECU 101 transmits a cutoff notification to turn off the electronic fuse 195 to the zone ECU 104 in process P132. When the zone ECU 104 receives the cutoff notification, it transmits a cutoff notification to the subordinate slave ECU 108 in process P133.

When the slave ECU 108 receives the cutoff notification, it transmits an acknowledgment response to the zone ECU 104 as illustrated by process P134. The slave ECU 108 that has transmitted the acknowledgment response executes the shutdown sequence as illustrated by process P135.

The zone ECU 104 that has transmitted the acknowledgment response transmits the acknowledgment response to the central ECU 101 as illustrated by process P136. The central ECU 101 that has received the acknowledgment response sets the completion time corresponding to the received acknowledgment response as the waiting time in process P137.

The central ECU 101 waits until the completion time elapses in process P138. When the completion time elapses, the central ECU 101 transmits a fuse-off instruction to turn off the electronic fuse 195 to the zone ECU 104 in process P139.

When the zone ECU 104 receives the fuse-off instruction, it switches the electronic fuse 195 from the on state to the off state as illustrated by process P140. In the communication system 100 configured as described above, the central ECU 101 transmits a cutoff notification to the slave ECU 108 via the zone ECU 104. After transmitting the cutoff notification, when the central ECU 101 receives an acknowledgment response including completion time information indicating the time required to complete the shutdown sequence from the slave ECU 108 via the zone ECU 104, it determines that the slave ECU 108 is in a cutoff-allowable state when the completion time has elapsed after receiving the acknowledgment response.

Such a communication system 100 can suppress the occurrence of a situation where the electronic fuse 195 is switched from the conduction state to the cutoff state even though the power supply to the slave ECU 108 should not be cut off because the shutdown sequence has not been completed. Therefore, the communication system 1 can improve the reliability of control for supplying power to the slave ECU 108.

In the embodiment described above, the slave ECU 108 corresponds to the first control device, the central ECU 101 and the zone ECU 104 correspond to the second control device, and the electronic fuse 195 corresponds to the power supply switching section.

### Tenth Embodiment

Hereinafter, the tenth embodiment of the present disclosure will be described with reference to the drawings. In the tenth embodiment, components different from the seventh embodiment will be described.

The zone ECUs 104 to 107 are configured to execute a process corresponding to the management process of the fifth embodiment. That is, the zone ECUs 104 to 107 acquire current value information from the subordinate electronic fuses to calculate the consumption current difference. Then, the zone ECUs 104 to 107 turn off the electronic fuses connected to the slave ECUs for which the calculated consumption current difference is greater than the off determination value and the NM frame instructing activation has not been transmitted. The zone ECUs 104 to 107 may notify the central ECU 101 that the electronic fuses have been turned off.

In the communication system 100 configured as described above, the zone ECU 104 calculates the consumption current difference for the slave ECU 108 and confirms whether an NM frame including activation information indicating whether to activate the slave ECU 108 has been transmitted to the zone ECU 104. The zone ECU 104 determines that the slave ECU 108 is in a cutoff-allowable state when a preset cutoff determination condition indicating that the consumption current difference is large is satisfied and the NM frame instructing the activation of the slave ECU 108 has not been transmitted to the zone ECU 104.

Such a communication system 100 can suppress the occurrence of a situation where the electronic fuse 195 remains in the conduction state even though the power supply to the slave ECU 108 can be cut off because the slave ECU 108 is transitioning to the sleep state. Therefore, the communication system 100 can improve the reliability of control for supplying power to the slave ECU 108.

In the embodiment described above, the slave ECU 108 corresponds to the first control device, the central ECU 101 and the zone ECU 104 correspond to the second control device, and the electronic fuse 195 corresponds to the power supply switching section.

### Eleventh Embodiment

Hereinafter, the eleventh embodiment of the present disclosure will be described with reference to the drawings. In the eleventh embodiment, components different from the seventh embodiment will be described.

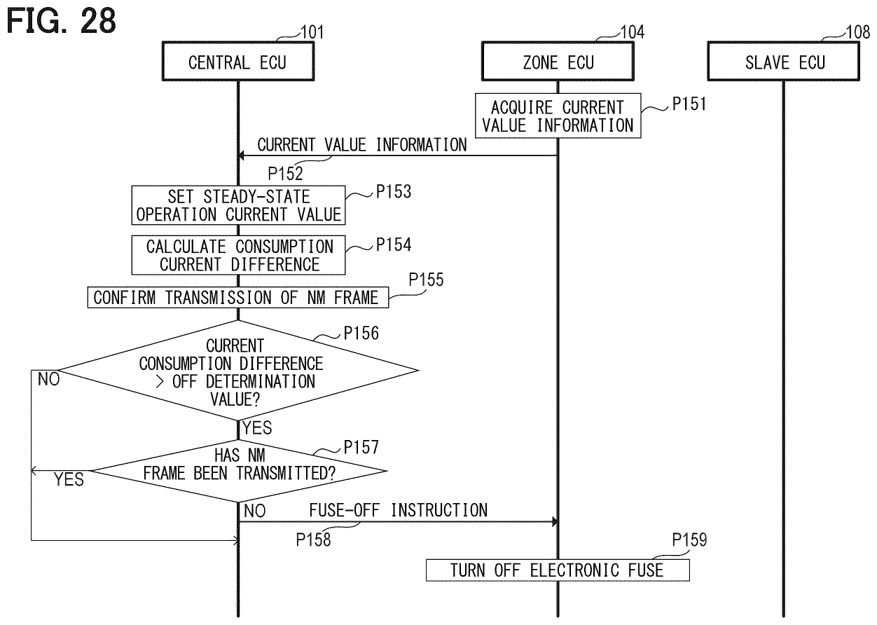

The form in which the zone ECU 104 measures the current and the central ECU 101 transmits the fuse-off instruction will be described with reference to FIG. 28. The zone ECU 104 acquires current value information from the electronic fuse 195 connected to the slave ECU 108 as illustrated by process P151 in FIG. 28.

The zone ECU 104 transmits the acquired current value information to the central ECU 101 as illustrated by process P152. The central ECU 101 sets the steady-state operation current value of the slave ECU 108 as illustrated by process P153.

The central ECU 101 calculates the consumption current difference for the slave ECU 108 as illustrated by process P154. The central ECU 101 confirms whether an NM frame instructing the activation of the slave ECU 108 has been transmitted as illustrated by process P155.

The central ECU 101 determines whether the consumption current difference for the slave ECU 108 is greater than the preset off determination value as illustrated by process P156. The central ECU 101 determines whether an NM frame instructing the activation of the slave ECU 108 has been transmitted as illustrated by process P157.

Then, if the consumption current difference for the slave ECU 108 is greater than the off determination value and the NM frame instructing the activation of the slave ECU 108 has not been transmitted, the central ECU 101 transmits a fuse-off instruction to turn off the electronic fuse 195 to the zone ECU 104 as illustrated by process P158.

When the zone ECU 104 receives the fuse-off instruction, it switches the electronic fuse 195 from the on state to the off state as illustrated by process P159. In the communication system 100 configured as described above, the central ECU 101 calculates the consumption current difference for the slave ECU 108 and confirms whether an NM frame including activation information indicating whether to activate the slave ECU 108 has been transmitted to the central ECU 101. The central ECU 101 determines that the slave ECU 108 is in a cutoff-allowable state when a preset cutoff determination condition indicating that the consumption current difference is large is satisfied and the NM frame instructing the activation of the slave ECU 108 has not been transmitted to the central ECU 101.

Such a communication system 100 can suppress the occurrence of a situation where the electronic fuse 195 remains in the conduction state even though the power supply to the slave ECU 108 can be cut off because the slave ECU 108 is transitioning to the sleep state. Therefore, the communication system 100 can improve the reliability of control for supplying power to the slave ECU 108.

In the embodiment described above, the slave ECU 108 corresponds to the first control device, the central ECU 101 and the zone ECU 104 correspond to the second control device, and the electronic fuse 195 corresponds to the power supply switching section.

### Twelfth Embodiment

Hereinafter, the twelfth embodiment of the present disclosure will be described with reference to the drawings. In the twelfth embodiment, components different from the seventh embodiment will be described.

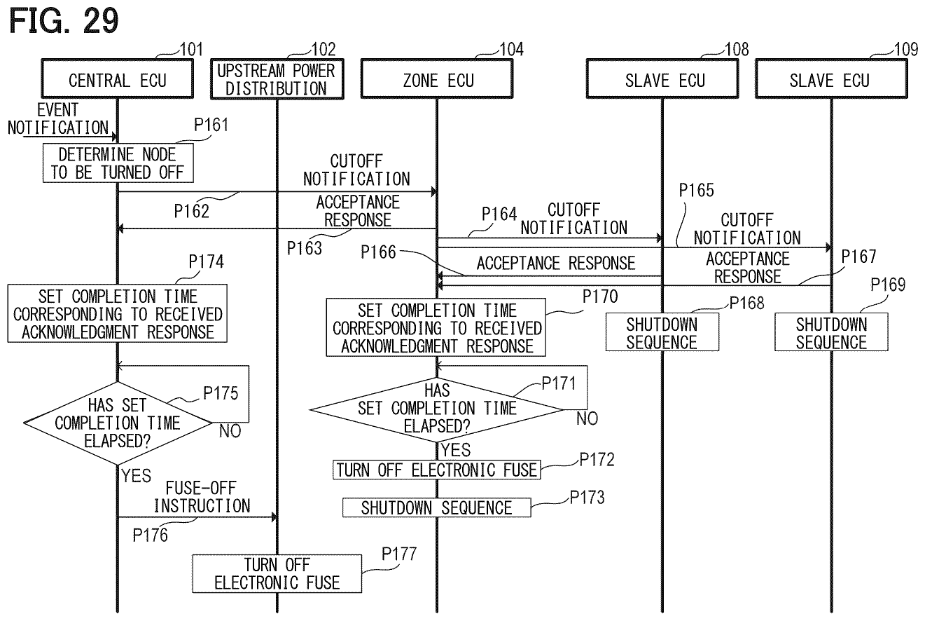

The form in which the central ECU 101 turns off the zone ECU 104 after the completion time has elapsed will be described with reference to FIG. 29. When the central ECU 101 receives an event notification (for example, IG off), it determines the node to be turned off (for example, the zone ECU 104) as illustrated by process P161 in FIG. 29.

The central ECU 101 transmits a cutoff notification to turn off the electronic fuse 173 to the zone ECU 104 in process P162. When the zone ECU 104 receives the cutoff notification, it transmits an acknowledgment response to the central ECU 101 as illustrated by process P163.

The zone ECU 104 also transmits cutoff notifications to the subordinate slave ECUs 108 and 109 as illustrated by processes P164 and P165. When the slave ECUs 108 and 109 receive the cutoff notifications, they transmit acknowledgment responses to the zone ECU 104 as illustrated by processes P166 and P167.

The slave ECUs 108 and 109 that have transmitted the acknowledgment responses execute the shutdown sequence as illustrated by processes P168 and P169. The zone ECU 104 that has transmitted the acknowledgment responses sets the completion time corresponding to the received acknowledgment responses as the waiting time in process P170. The waiting time is the longer of the completion times of the slave ECU 108 and the slave ECU 109.

The zone ECU 104 waits until the completion time elapses in process P171. When the completion time elapses, the zone ECU 104 turns off the electronic fuses 195 and 196 as illustrated by process P172.

The zone ECU 104 executes the shutdown sequence as illustrated by process P173. The central ECU 101 that has received the acknowledgment response from the zone ECU 104 sets the completion time corresponding to the received acknowledgment response as the waiting time in process P174. The completion time of process P174 is set to be longer than the sum of the completion time of process P170 and the time of the shutdown sequence of process P173.

The central ECU 101 waits until the completion time elapses in process P175. When the completion time elapses, the central ECU 101 transmits a fuse-off instruction to turn off the electronic fuse 173 to the upstream power distribution section 102 in process P176.

When the upstream power distribution section 102 receives the fuse-off instruction, it switches the electronic fuse 173 from the on state to the off state as illustrated by process P177. In the communication system 100 configured as described above, when the zone ECU 104 receives a cutoff notification to turn off the electronic fuse 173 from the central ECU 101, it transmits an acknowledgment response including completion time information indicating the time required to complete the cutoff of the electronic fuse 173 to the central ECU 101. The zone ECU 104 further transmits a cutoff notification to the slave ECU 108. After transmitting the cutoff notification, when the zone ECU 104 receives an acknowledgment response including completion time information indicating the time required to complete the shutdown sequence from the slave ECU 108, it determines that the slave ECU 108 is in a cutoff-allowable state when the completion time has elapsed after receiving the acknowledgment response.

After transmitting the cutoff notification, when the central ECU 101 receives an acknowledgment response from the zone ECU 104, it transmits a fuse-off instruction to turn off the electronic fuse 173 to the upstream power distribution section 102 when the completion time has elapsed after receiving the acknowledgment response.

Such a communication system 100 can suppress the occurrence of a situation where the electronic fuse 195 remains in the conduction state even though the power supply to the slave ECU 108 can be cut off because the slave ECU 108 is transitioning to the sleep state. Therefore, the communication system 100 can improve the reliability of control for supplying power to the slave ECU 108.

In the embodiment described above, the slave ECU 108 corresponds to the first control device, the central ECU 101 and the zone ECU 104 correspond to the second control device, the electronic fuse 195 corresponds to the first power supply switching section, and the electronic fuse 173 corresponds to the second power supply switching section.

Furthermore, the cutoff notification in process P162 corresponds to the power supply cutoff notification, the information indicating the completion time corresponding to the acknowledgment response in process P166 corresponds to the second completion time information indicating the second completion time, and the acknowledgment response in process P166 corresponds to the second acknowledgment response.

Furthermore, the information indicating the completion time corresponding to the acknowledgment response in process P163 corresponds to the first completion time information indicating the first completion time, the acknowledgment response in process P163 corresponds to the first acknowledgment response, and the fuse-off instruction in process P176 corresponds to the second power supply cutoff instruction.

### Thirteenth Embodiment

Hereinafter, the thirteenth embodiment of the present disclosure will be described with reference to the drawings. In the thirteenth embodiment, components different from the seventh embodiment will be described.

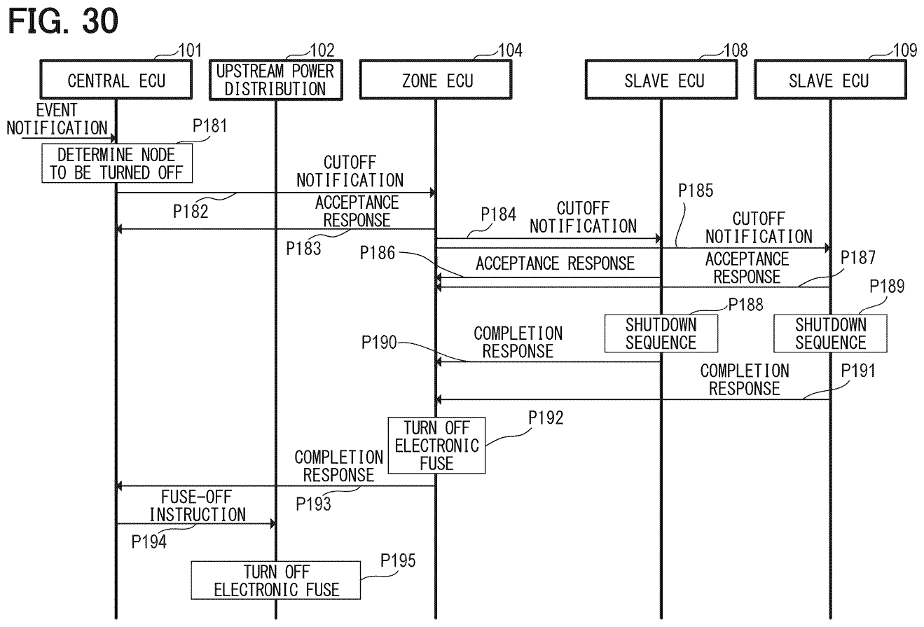

The form in which the central ECU 101 turns off the zone ECU 104 after receiving the completion response will be described with reference to FIG. 30. When the central ECU 101 receives an event notification (for example, IG off), it determines the node to be turned off (for example, the zone ECU 104) as illustrated by process P181 in FIG. 30.

The central ECU 101 transmits a cutoff notification to turn off the electronic fuse 173 to the zone ECU 104 in process P182. When the zone ECU 104 receives the cutoff notification, it transmits an acknowledgment response to the central ECU 101 as illustrated by process P183.

The zone ECU 104 also transmits cutoff notifications to the subordinate slave ECUs 108 and 109 as illustrated by processes P184 and P185. When the slave ECUs 108 and 109 receive the cutoff notifications, they transmit acknowledgment responses to the zone ECU 104 as illustrated by processes P186 and P187.

The slave ECUs 108 and 109 that have transmitted the acknowledgment responses execute the shutdown sequence as illustrated by processes P188 and P189. When the slave ECUs 108 and 109 complete the shutdown sequence, they transmit completion responses to the zone ECU 104 as illustrated by processes P190 and P191.

When the zone ECU 104 receives completion responses from both the slave ECUs 108 and 109, it turns off the electronic fuses 195 and 196 as illustrated by process P192. The zone ECU 104 transmits a completion response to the central ECU 101 as illustrated by process P193.

When the central ECU 101 receives the completion response from the zone ECU 104, it transmits a fuse-off instruction to turn off the electronic fuse 173 to the upstream power distribution section 102 as illustrated by process P194.

When the upstream power distribution section 102 receives the fuse-off instruction, it switches the electronic fuse 173 from the on state to the off state as illustrated by process P195. In the communication system 100 configured as described above, when the zone ECU 104 receives a cutoff notification to turn off the electronic fuse 173 from the central ECU 101, it transmits an acknowledgment response to the central ECU 101 and further transmits a cutoff notification to the slave ECU 108. When the zone ECU 104 receives a completion response from the slave ECU 108 after transmitting the cutoff notification, it determines that the slave ECU 108 is in a cutoff-allowable state, turns off the electronic fuse 195, and further transmits the completion response to the central ECU 101.

After transmitting the cutoff notification, when the central ECU 101 receives the completion response from the zone ECU 104, it transmits a fuse-off instruction to turn off the electronic fuse 173 to the upstream power distribution section 102.

Such a communication system 100 can suppress the occurrence of a situation where the electronic fuse 195 remains in the conduction state even though the power supply to the slave ECU 108 can be cut off because the slave ECU 108 is transitioning to the sleep state. Therefore, the communication system 100 can improve the reliability of control for supplying power to the slave ECU 108.

In the embodiment described above, the cutoff notification in process P182 corresponds to the power supply cutoff notification, the acknowledgment response in process P183 corresponds to the first acknowledgment response, the completion response in process P190 corresponds to the first completion response, the completion response in process P193 corresponds to the second completion response, and the fuse-off instruction in process P194 corresponds to the second power supply cutoff instruction.

### Fourteenth Embodiment

Hereinafter, the fourteenth embodiment of the present disclosure will be described with reference to the drawings. In the fourteenth embodiment, components different from the seventh embodiment will be described.

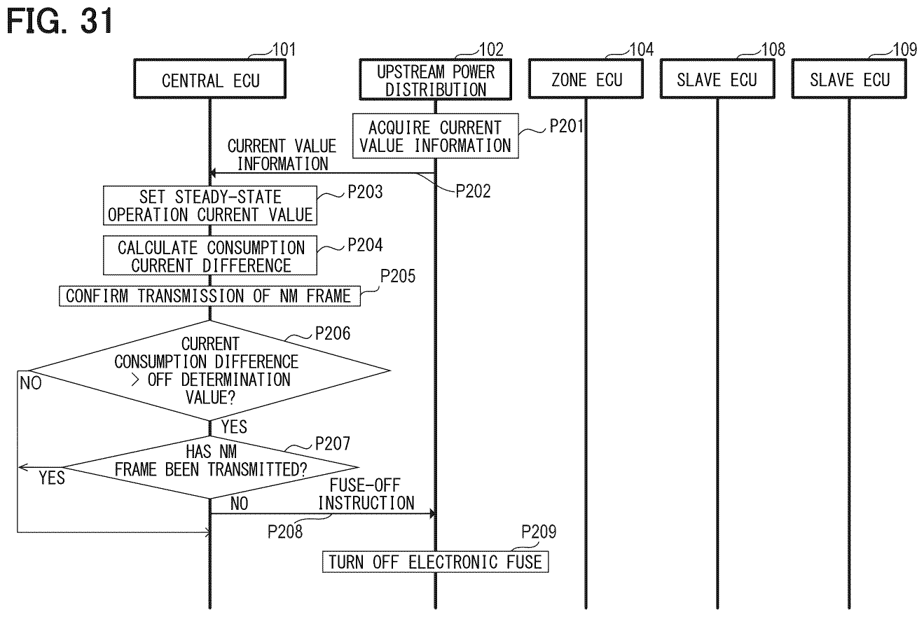

The form in which the upstream power distribution section 102 measures the current and the central ECU 101 transmits the fuse-off instruction will be described with reference to FIG. 31. The upstream power distribution section 102 acquires current value information from the electronic fuse 173 connected to the zone ECU 104 as illustrated by process P201 in FIG. 31.

The upstream power distribution section 102 transmits the acquired current value information to the central ECU 101 as illustrated by process P202. The central ECU 101 sets the steady-state operation current value of the zone ECU 104 as illustrated by process P203.

The central ECU 101 calculates the consumption current difference for the zone ECU 104 as illustrated by process P204. The central ECU 101 confirms whether an NM frame instructing the activation of the zone ECU 104 has been transmitted as illustrated by process P205.

The central ECU 101 determines whether the consumption current difference for the zone ECU 104 is greater than the preset off determination value as illustrated by process P206. The central ECU 101 determines whether an NM frame instructing the activation of the zone ECU 104 has been transmitted as illustrated by process P207.

Then, if the consumption current difference for the zone ECU 104 is greater than the off determination value and the NM frame instructing the activation of the zone ECU 104 has not been transmitted, the central ECU 101 transmits a fuse-off instruction to turn off the electronic fuse 173 to the upstream power distribution section 102 as illustrated by process P208.

When the upstream power distribution section 102 receives the fuse-off instruction, it switches the electronic fuse 173 from the on state to the off state as illustrated by process P209. In the communication system 100 configured as described above, the central ECU 101 calculates the consumption current difference for the zone ECU 104 and confirms whether an NM frame including activation information indicating whether to activate the zone ECU 104 has been transmitted to the central ECU 101. The central ECU 101 determines that the zone ECU 104 is in a cutoff-allowable state when a preset cutoff determination condition indicating that the consumption current difference is large is satisfied and the NM frame instructing the activation of the zone ECU 104 has not been transmitted to the central ECU 101, and transmits a fuse-off instruction to turn off the electronic fuse 173 to the upstream power distribution section 102.

Such a communication system 100 can suppress the occurrence of a situation where the electronic fuse 173 remains in the conduction state even though the power supply to the zone ECU 104 can be cut off because the zone ECU 104 is transitioning to the sleep state. Therefore, the communication system 100 can improve the reliability of control for supplying power to the zone ECU 104.

In the embodiment described above, the electronic fuse 195 corresponds to the first power supply switching section, the electronic fuse 173 corresponds to the second power supply switching section, and the fuse-off instruction in process P208 corresponds to the second power supply cutoff instruction.

### Fifteenth Embodiment

Hereinafter, the fifteenth embodiment of the present disclosure will be described with reference to the drawings. In the fifteenth embodiment, components different from the seventh embodiment will be described.

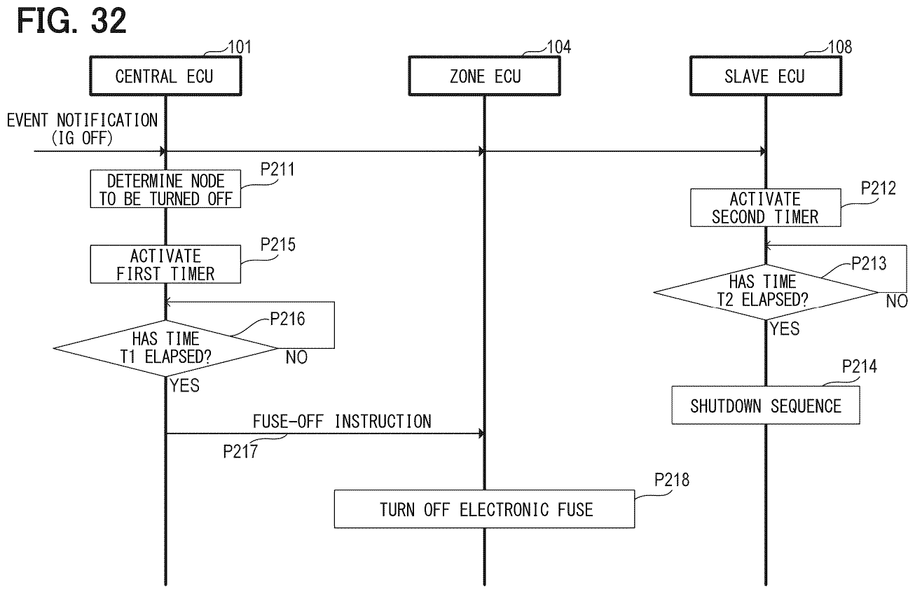

The form in which the central ECU 101 and the slave ECU 108 use timers to switch the electronic fuse to the off state will be described with reference to FIG. 32. The central ECU 101, the zone ECU 104, and the slave ECU 108 receive an event notification (for example, IG off) transmitted by broadcast, for example.

When the central ECU 101 receives the event notification, it determines the node to be turned off (for example, the slave ECU 108) as illustrated by process P211 in FIG. 32. When the slave ECU 108 receives the event notification, it activates the second timer mounted on the slave ECU 108 as illustrated by process P212. The second timer is a timer that starts incrementing when activated.

The slave ECU 108 waits until a preset time T2 (for example, 3 minutes) elapses based on the value of the second timer as illustrated by process P213. When the time T2 elapses, the slave ECU 108 executes the shutdown sequence as illustrated by process P214.

After process P211 is completed, the central ECU 101 activates the first timer mounted on the central ECU 101 as illustrated by process P215. The first timer is a timer that starts incrementing when activated.

The central ECU 101 waits until a preset time T1 (for example, 5 minutes) elapses, which is set to be longer than the time T2, based on the value of the first timer as illustrated by process P216. When the time T1 elapses, the central ECU 101 transmits a fuse-off instruction to turn off the electronic fuse 195 to the zone ECU 104 as illustrated by process P217.

When the zone ECU 104 receives the fuse-off instruction, it switches the electronic fuse 195 from the on state to the off state as illustrated by process P218. In the communication system 100 configured as described above, the slave ECU 108 executes the shutdown sequence when the preset time T2 elapses after receiving the event notification. The central ECU 101 transmits a fuse-off instruction to turn off the electronic fuse 195 to the zone ECU 104 when the preset time T1, which is set to be longer than the time T2, elapses after receiving the event notification.

Such a communication system 100 can suppress the occurrence of a situation where the electronic fuse 195 remains in the conduction state even though the power supply to the slave ECU 108 can be cut off because the slave ECU 108 is transitioning to the sleep state. Therefore, the communication system 100 can improve the reliability of control for supplying power to the slave ECU 108.

In the embodiment described above, the time T1 corresponds to the first waiting time, the time T2 corresponds to the second waiting time, and the fuse-off instruction in process P217 corresponds to the power supply cutoff instruction.

### Sixteenth Embodiment

Hereinafter, the sixteenth embodiment of the present disclosure will be described with reference to the drawings. In the sixteenth embodiment, components different from the seventh embodiment will be described.

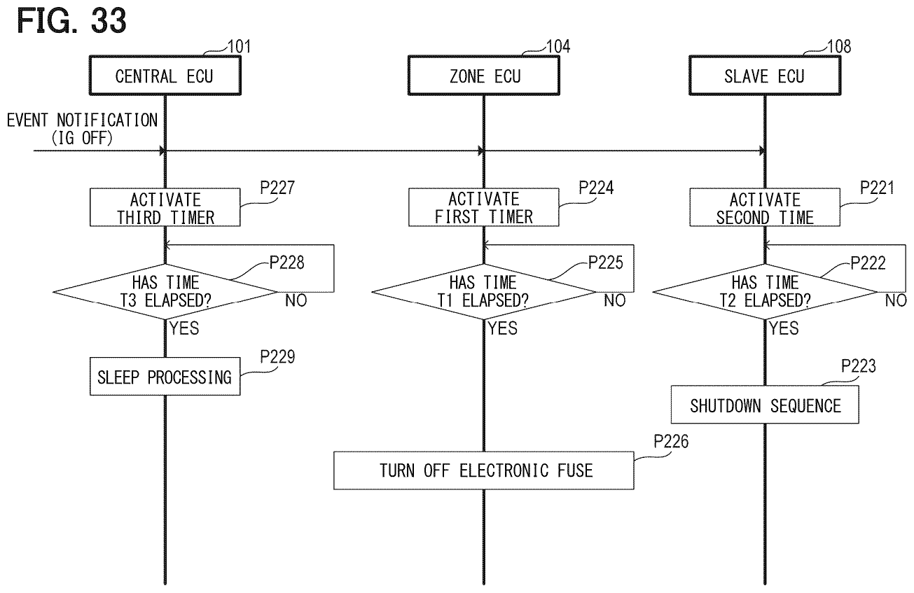

The form in which the central ECU 101, the zone ECU 104, and the slave ECU 108 use timers to switch the electronic fuse to the off state will be described with reference to FIG. 33. The central ECU 101, the zone ECU 104, and the slave ECU 108 receive an event notification (for example, IG off) transmitted by broadcast, for example.

When the slave ECU 108 receives the event notification, it activates the second timer mounted on the slave ECU 108 as illustrated by process P221. The second timer is a timer that starts incrementing when activated.

The slave ECU 108 waits until a preset time T2 (for example, 3 minutes) elapses based on the value of the second timer as illustrated by process P222. When the time T2 elapses, the slave ECU 108 executes the shutdown sequence as illustrated by process P223.

When the zone ECU 104 receives the event notification, it activates the first timer mounted on the zone ECU 104 as illustrated by process P224. The first timer is a timer that starts incrementing when activated.

The zone ECU 104 waits until a preset time T1 (for example, 5 minutes) elapses, which is set to be longer than the time T2, based on the value of the first timer as illustrated by process P225.

When the time T1 elapses, the zone ECU 104 switches the electronic fuse 195 from the on state to the off state as illustrated by process P226. When the central ECU 101 receives the event notification, it activates the third timer mounted on the central ECU 101 as illustrated by process P227. The third timer is a timer that starts incrementing when activated.

The central ECU 101 waits until a preset time T3 (for example, 3 minutes) elapses based on the value of the third timer as illustrated by process P228. When the time T3 elapses, the central ECU 101 executes the sleep process and transitions to the sleep state as illustrated by process P229.

In the communication system 100 configured as described above, the slave ECU 108 executes the shutdown sequence when the preset time T2 elapses after receiving the event notification. The zone ECU 104 switches the electronic fuse 195 to the off state when the preset time T1, which is set to be longer than the time T2, elapses after receiving the event notification.

Such a communication system 100 can suppress the occurrence of a situation where the electronic fuse 195 remains in the conduction state even though the power supply to the slave ECU 108 can be cut off because the slave ECU 108 is transitioning to the sleep state. Therefore, the communication system 100 can improve the reliability of control for supplying power to the slave ECU 108.

In the embodiment described above, the time T1 corresponds to the first waiting time, and the time T2 corresponds to the second waiting time. Although one embodiment of the present disclosure has been described above, the present disclosure is not limited to the above embodiment and can be implemented in various modified forms.

### (Modification Example 1)

In the above embodiment, a form in which a handshake is executed via the communication bus 8 between the master ECU 2 and the slave ECUs 3 to 5 was shown, but a handshake may be executed via a direct line connecting the master ECU 2 and the slave ECUs 3 to 5.

### Modification Example 2

In the fifth embodiment, a form was shown in which it is confirmed whether an NM frame instructing the activation of the slave ECUs 3 to 5 has been transmitted within the transmission determination time from the current time. However, regardless of whether the NM frame instructs the activation of the slave ECUs 3 to 5, if the master ECU 2 has not received the NM frame within the transmission determination time from the current time, the electronic fuses connected to the slave ECUs with a consumption current difference greater than the off determination value may be turned off.

### Modification Example 3

In the fifth embodiment, a form was shown in which the steady-state operation current value is calculated based on the current value information acquired from the electronic fuses 18 to 20. However, a predetermined value set as the current value during steady-state operation may be set as the steady-state operation current value.

### Modification Example 4

In the first to fourth embodiments, a form was shown in which power supply is controlled using the relays 15, 16, and 17, but electronic fuses may be used instead of the relays 15, 16, and 17. In the fifth embodiment, a form was shown in which power supply is controlled using the electronic fuses 18, 19, and 20, but relays may be used instead of the electronic fuses 18, 19, and 20.

### Modification Example 5

In the twelfth, thirteenth, and fourteenth embodiments, a form was shown in which the central ECU 101 transmits a fuse-off instruction to the upstream power distribution section 102 with the built-in electronic fuse 173. However, if the central ECU 101 has a built-in electronic fuse 173, the central ECU 101 itself may turn off the electronic fuse 173.

### Modification Example 6

In the fifteenth and sixteenth embodiments, a form was shown in which the central ECU 101, the zone ECU 104, and the slave ECU 108 receive an event notification transmitted by broadcast.

However, in the fifteenth embodiment, the central ECU 101 may transmit an instruction to the slave ECU 108, such as “off after 3 minutes.” The central ECU 101 may also transmit that the electronic fuse 195 is to be turned off by transmitting an NM frame.

In the sixteenth embodiment, the central ECU 101 may transmit an instruction to the zone ECU 104 and the slave ECU 108, such as “off after 3 minutes.” The central ECU 101 may also transmit that the electronic fuse 195 is to be turned off by transmitting an NM frame.

The control sections 11 and 31 and their methods described in the present disclosure may be implemented by a dedicated computer provided by configuring a processor and memory programmed to execute one or more functions materialized by a computer program. Alternatively, the control sections 11 and 31 and their methods described in the present disclosure may be implemented by a dedicated computer provided by configuring a processor with one or more dedicated hardware logic circuits. Alternatively, the control sections 11 and 31 and their methods described in the present disclosure may be implemented by one or more dedicated computers configured by a combination of a processor and memory programmed to execute one or more functions and one or more hardware logic circuits. The computer program may be stored in a computer-readable non-transitory tangible storage medium as instructions executed by a computer. The methods for realizing the functions of the respective sections included in the control sections 11 and 31 do not necessarily have to include software, and all the functions may be realized using one or more hardware.

The multiple functions possessed by one component in the above embodiment may be realized by multiple components, or one function possessed by one component may be realized by multiple components. Furthermore, the multiple functions possessed by multiple components may be realized by one component, or one function realized by multiple components may be realized by one component. Additionally, part of the configuration of the above embodiment may be omitted. Furthermore, at least part of the configuration of the above embodiment may be added to or replaced with the configuration of another embodiment.

In addition to the ECUs 2 to 6, 101, and 104 to 116 described above, the present disclosure can be realized in various forms such as a system including the ECUs 2 to 6, 101, and 104 to 116 as components, a program for making a computer function as the ECUs 2 to 6, 101, and 104 to 116, a non-transitory tangible storage medium such as a semiconductor memory recording the program, and a communication management method.

What is claimed is:

1. A communication system comprising:
a first control device configured to receive a power supply from a power source via a power supply switching section configured to switch between a conduction state in which a power supply path is conducted and a cutoff state in which the power supply path is cut off;
a second control device that is data-communicably connected to the first control device and is configured to control an operation of the power supply switching section,
wherein
the second control device includes:
a state confirmation section configured to determine whether the first control device is in a cutoff-allowable state in which the power supply switching section may be brought into the cutoff state, and
a power supply control section configured to bring the power supply switching section into the cutoff state when the state confirmation section determines that the first control device is in the cutoff-allowable state.

2. The communication system according to claim 1, wherein
the state confirmation section is configured to determine whether the first control device is in the cutoff-allowable state by performing data communication with the first control device.

3. The communication system according to claim 2, wherein
the state confirmation section is configured to transmit a cutoff notification indicating to switch the power supply switching section to the cutoff state to the first control device, and
the state confirmation section is configured to determine that the first control device is in the cutoff-allowable state when a completion response indicating that a shutdown sequence is completed is received from the first control device.

4. The communication system according to claim 2, wherein
the state confirmation section is configured to transmit a cutoff notification indicating to switch the power supply switching section to the cutoff state to the first control device, and
the state confirmation section is configured to determine that the first control device is in the cutoff-allowable state when a completion time required to complete a shutdown sequence has elapsed after receiving an acknowledgment response including completion time information indicating the completion time from the first control device after transmitting the cutoff notification.

5. The communication system according to claim 2, wherein
the state confirmation section is configured to transmits an acknowledgment response to the first control device upon receiving a sleep notification indicating a transition to a sleep state from the first control device, and
the state confirmation section is configured to determine that the first control device is in the cutoff-allowable state when a completion response indicating that a shutdown sequence is completed is received from the first control device after transmitting the acknowledgment response.

6. The communication system according to claim 2, wherein
the state confirmation section includes completion time information indicating a completion time required to complete a shutdown sequence, and
the state confirmation section is configured to determine that the first control device is in the cutoff-allowable state when the completion time has elapsed after receiving a cutoff request indicating to switch the power supply switching section to the cutoff state from the first control device.

7. The communication system according to claim 1, wherein
the state confirmation section is configured to calculate a consumption current difference as a difference between a steady-state operation current value, which is a value of current consumed during steady-state operation of the first control device, and a value of current consumed at the present time,
the state confirmation section is configured to determine whether a management frame, which is a communication frame including activation information indicating whether to activate the first control device, has been transmitted to the second control device, and
the state confirmation section is further configured to determine that the first control device is in the cutoff-allowable state when a preset cutoff determination condition indicating that the consumption current difference is large is satisfied and the management frame has not been transmitted to the second control device.

8. The communication system according to claim 7, wherein
the state confirmation section is configured to set the steady-state operation current value by measuring a current flowing through the power supply switching section during the steady-state operation.

9. The communication system according to claim 2, wherein
the state confirmation section is configured to transmit a pre-notification message to the first control device indicating that the power supply switching section will be brought into the cutoff state before bringing the power supply switching section into the cutoff state, and
the state confirmation section is configured to determine to be in the cutoff-allowable state when a preset shutdown processing required time, which is a time required for the first control device to execute shutdown processing, has elapsed after transmitting the pre-notification message.

10. The communication system according to claim 9, wherein
the shutdown processing required time is individually set for each of one or more control devices connected to one or more of power supply switching sections.

11. The communication system according to claim 2, wherein
the communication system is configured to transmit and receive a management frame, which is a communication frame including switching information indicating whether to bring the power supply switching section into the conduction state and activation information indicating whether to activate the second control device,
the state confirmation section is configured to stop transmitting the management frame when a preset sleep condition for switching the second control device to a sleep state is satisfied, and
the state confirmation section is configured to determine to be the cutoff-allowable state when a total time of a time for the first control device to determine interruption of the management frame and a time required for the first control device to execute shutdown processing has elapsed.

12. The communication system according to claim 2, wherein
the communication system is configured to transmit and receive a management frame, which is a communication frame including switching information indicating whether to bring the power supply switching section into the conduction state and activation information indicating whether to activate the second control device,
the state confirmation section is configured to change all data sequences corresponding to the switching information and the activation information included in the management frame from active values to inactive values when a preset sleep condition for switching the second control device to a sleep state is satisfied, and
the state confirmation section is configured to determine to be the cutoff-allowable state when a certain time has elapsed after all data sequences corresponding to the switching information and the activation information have become inactive values.

13. The communication system according to claim 4, wherein
the communication system includes:
a slave control device as the first control device;
a zone control device that is data-communicably connected to the slave control device and is configured to control an operation of the power supply switching section and a central control device that is data-communicably connected to the zone control device as the second control device,
the zone control device includes the state confirmation section, and
the state confirmation section of the zone control device is configured to transmit a cutoff notification to the slave control device upon receiving a power supply cutoff instruction to bring the power supply switching section into the cutoff state from the central control device, and
the state confirmation section of the zone control device determines that the slave control device is in the cutoff-allowable state when the completion time has elapsed after receiving the acknowledgment response including the completion time information indicating the completion time required to complete the shutdown sequence from the slave control device after transmitting the cutoff notification.

14. The communication system according to claim 4, wherein
the communication system includes:
a slave control device as the first control device; and
a zone control device that is data-communicably connected to the slave control device and is configured to control an operation of the power supply switching section and a central control device that is data-communicably connected to the zone control device as the second control device,
the zone control device includes the state confirmation section, and
the state confirmation section of the zone control device is configured to transmit a cutoff notification to the slave control device upon receiving a pre-cutoff notification from the central control device indicating to bring the power supply switching section into the cutoff state, and
the state confirmation section of the zone control device
the state confirmation section of the zone control device is configured to transmit the cutoff notification to the slave control device upon receiving a preliminary cutoff notification to bring the power supply switching section into the cutoff state from the central control device,
the state confirmation section of the zone control device is configured to transmit a handshake completion notification to the central control device when the completion time has elapsed after receiving the acknowledgment response including the completion time information indicating the completion time required to complete the shutdown sequence from the slave control device after transmitting the cutoff notification, and
the state confirmation section of the zone control device is configured to determine that the slave control device is in the cutoff-allowable state upon receiving a power supply cutoff instruction to bring the power supply switching section into the cutoff state from the central control device after transmitting the handshake completion notification.

15. The communication system according to claim 4, wherein
the communication system includes:
a slave control device as the first control device; and
a zone control device that is data-communicably connected to the slave control device and is configured to control an operation of the power supply switching section and a central control device that is data-communicably connected to the zone control device as the second control device,
the central control device includes the state confirmation section,
the zone control device includes the power supply control section,
the state confirmation section of the central control device is configured to transmit a cutoff notification to the slave control device via the zone control device, and
the state confirmation section of the central control device is configured to determine that the slave control device is in the cutoff-allowable state when the completion time has elapsed after receiving the acknowledgment response including the completion time information indicating the completion time required to complete the shutdown sequence from the slave control device via the zone control device after transmitting the cutoff notification.

16. The communication system according to claim 7, wherein
the communication system includes:
a slave control device as the first control device; and
a zone control device that is data-communicably connected to the slave control device and is configured to control an operation of the power supply switching section and a central control device that is data-communicably connected to the zone control device as the second control device,
the zone control device includes the state confirmation section and the power supply control section,
the state confirmation section is configured to calculate the consumption current difference for the slave control device, and determine whether the management frame including the activation information indicating whether to activate the slave control device has been transmitted to the zone control device, and
the power supply control section is configured to determine that the slave control device is in the cutoff-allowable state when the cutoff determination condition is satisfied and the management frame has not been transmitted to the zone control device.

17. The communication system according to claim 7, wherein
the communication system includes:
a slave control device as the first control device; and
a zone control device that is data-communicably connected to the slave control device and is configured to control an operation of the power supply switching section and a central control device that is data-communicably connected to the zone control device as the second control device,
the central control device includes the state confirmation section, and
the state confirmation section is configured to calculate the consumption current difference for the slave control device,
the state confirmation section is configured to determine whether the management frame including the activation information indicating whether to activate the slave control device has been transmitted to the central control device, and
the state confirmation section is further configured to determine that the first control device is in the cutoff-allowable state when the cutoff determination condition is satisfied and the management frame is not being transmitted to the central control device.

18. The communication system according to claim 4, wherein
the communication system includes:
a slave control device as the first control device;
a first power supply switching section as the power supply switching section; and
a zone control device that is data-communicably connected to the slave control device and is configured to control an operation of the first power supply switching section and a central control device that is data-communicably connected to the zone control device as the second control device,
the zone control device is configured to receive a power supply from the power source via a second power supply switching section configured to switch between the conduction state and the cutoff state and built into the central control device,
the zone control device includes the state confirmation section,
the state confirmation section of the zone control device is configured to transmit a second acknowledgment response including second completion time information indicating a second completion time required to complete cutoff of the second power supply switching section to the central control device upon receiving a power supply cutoff notification to bring the second power supply switching section into the cutoff state from the central control device,
the state confirmation section of the zone control device is further configured to transmit the cutoff notification to the slave control device,
the state confirmation section of the zone control device is configured to determine that the slave control device is in the cutoff-allowable state when a first completion time has elapsed after receiving a first acknowledgment response including first completion time information indicating the first completion time required to complete the shutdown sequence from the slave control device after transmitting the cutoff notification, and
the central control device is configured to bring the second power supply switching section into the cutoff state when the second completion time has elapsed after receiving the second acknowledgment response from the zone control device after transmitting the power supply cutoff notification.

19. The communication system according to claim 3, wherein
the communication system includes:
a slave control device as the first control device;
a first power supply switching section as the power supply switching section; and
a zone control device that is data-communicably connected to the slave control device and is configured to control an operation of the first power supply switching section and a central control device that is data-communicably connected to the zone control device as the second control device,
the zone control device is configured to receive a power supply from the power source via a second power supply switching section configured to switch between the conduction state and the cutoff state and built into the central control device,
the zone control device includes the state confirmation section,
the state confirmation section of the zone control device is configured to transmit a first acknowledgment response to the central control device upon receiving a power supply cutoff notification to bring the first power supply switching section into the cutoff state from the central control device,
the state confirmation section of the zone control device is further configured to transmit the cutoff notification to the slave control device,
the state confirmation section of the zone control device is configured to determine that the slave control device is in the cutoff-allowable state upon receiving a first completion response from the slave control device after transmitting the cutoff notification, and transmit a second completion response to the central control device, and
the central control device is configured to bring the second power supply switching section into the cutoff state upon receiving the second completion response from the zone control device after transmitting the power supply cutoff notification.

20. The communication system according to claim 7, wherein
the communication system includes:
a zone control device as the first control device;
a second power supply switching section as the power supply switching section;
a central control device that is data-communicably connected to the zone control device and includes the second power supply switching section as the second control device; and
a slave control device that receives a power supply from the power source via a first power supply switching section built into the zone control device,
the central control device includes the state confirmation section and the power supply control section, and
the state confirmation section of the central control device is configured to calculate the consumption current difference for the zone control device,
the state confirmation section of the central control device is configured to determine whether the management frame including the activation information indicating whether to activate the zone control device has been transmitted to the central control device, and
the state confirmation section of the central control device is further configured to determine that the zone control device is in the cutoff-allowable state when the cutoff determination condition is satisfied and the management frame has not been transmitted to the central control device.

21. The communication system according to claim 4, wherein
the communication system includes:
a slave control device as the first control device;
a first power supply switching section as the power supply switching section; and
a zone control device that is data-communicably connected to the slave control device and includes the first power supply switching section, and is configured to receive a power supply from the power source via a second power supply switching section configured to switch between the conduction state and the cutoff state and a central control device that is data-communicably connected to the zone control device as the second control device; and
an upstream power distribution section including the second power supply switching section,
the zone control device includes the state confirmation section,
the state confirmation section of the zone control device is configured to transmit a second acknowledgment response including second completion time information indicating a second completion time required to complete cutoff of the second power supply switching section to the central control device upon receiving a power supply cutoff notification to bring the second power supply switching section into the cutoff state from the central control device,
the state confirmation section of the zone control device is further configured to transmit the cutoff notification to the slave control device,
the state confirmation section of the zone control device is configured to determine that the slave control device is in the cutoff-allowable state when a first acknowledgment response including first completion time information indicating a first completion time required to complete a shutdown sequence is received from the slave control device after transmitting the cutoff notification, and the first completion time has elapsed after receiving the first acknowledgment response, and
the central control device is configured to transmit a second power supply cutoff instruction to the upstream power distribution section to bring the second power supply switching section into the cutoff state when the second completion time has elapsed after receiving the second acknowledgment response from the zone control device after transmitting the power supply cutoff notification.

22. The communication system according to claim 3, wherein
the communication system includes:
a slave control device as the first control device;
a first power supply switching section as the power supply switching section;
a zone control device that is data-communicably connected to the slave control device and includes the first power supply switching section, and is configured to receive a power supply from the power source via a second power supply switching section configured to switch between the conduction state and the cutoff state and a central control device that is data-communicably connected to the zone control device as the second control device; and
an upstream power distribution section including the second power supply switching section,
the zone control device includes the state confirmation section,
the state confirmation section of the zone control device is configured to transmit a first acknowledgment response to the central control device upon receiving a power supply cutoff notification to bring the second power supply switching section into the cutoff state from the central control device,
the state confirmation section of the zone control device is further configured to transmit the cutoff notification to the slave control device,
the state confirmation section of the zone control device is configured to determine that the slave control device is in the cutoff-allowable state when a first completion response is received from the slave control device after transmitting the cutoff notification, and to bring the first power supply switching section into the cutoff state, and further to transmit a second completion response to the central control device, and
the central control device is configured to transmit a second power supply cutoff instruction to the upstream power distribution section to bring the second power supply switching section into the cutoff state upon receiving the second completion response from the zone control device after transmitting the power supply cutoff notification.

23. The communication system according to claim 7, wherein
the communication system includes:
a slave control device as the first control device;
a first power supply switching section as the power supply switching section;
a zone control device that is data-communicably connected to the slave control device and includes the first power supply switching section, and is configured to receive a power supply from the power source via a second power supply switching section configured to switch between the conduction state and the cutoff state and a central control device that is data-communicably connected to the zone control device as the second control device; and
an upstream power distribution section including the second power supply switching section,
the central control device includes the state confirmation section,
the state confirmation section of the central control device is configured to calculate the consumption current difference for the zone control device,
the state confirmation section of the central control device is configured to determine whether the management frame including the activation information indicating whether to activate the zone control device has been transmitted to the central control device, and
the state confirmation section of the central control device is further configured to determine that the zone control device is in the cutoff-allowable state when the cutoff determination condition is satisfied and the management frame has not been transmitted to the central control device, and to transmit a second power supply cutoff instruction to bring the second power supply switching section into the cutoff state to the upstream power distribution section.

24. The communication system according to claim 1, wherein
the communication system includes:
a slave control device as the first control device; and
a zone control device that is data-communicably connected to the slave control device and is configured to control an operation of the power supply switching section and a central control device that is data-communicably connected to the zone control device as the second control device,
a preset event notification is transmitted to the central control device, the zone control device, and the slave control device,
the slave control device is configured to execute a shutdown sequence when a preset second waiting time based on the event notification has elapsed after receiving the event notification, and
the central control device includes the state confirmation section and the power supply control section, and
the state confirmation section of the central control device is configured to determine that the cutoff-allowable state is established when a first waiting time, which is set to be longer than the second waiting time based on the event notification, has elapsed after receiving the event notification, and
the power supply control section of the central control device is configured to transmit a power supply cutoff instruction to the zone control device to bring the power supply switching section into the cutoff state when the state confirmation section determines that the cutoff-allowable state is established.

25. The communication system according to claim 1, wherein
the communication system includes:
a slave control device as the first control device; and
a zone control device that is data-communicably connected to the slave control device and is configured to control an operation of the power supply switching section and a central control device that is data-communicably connected to the zone control device as the second control device,
a preset event notification is transmitted to the central control device, the zone control device, and the slave control device,
the slave control device is configured to execute a shutdown sequence when a preset second waiting time has elapsed after receiving the event notification based on the event notification, and
the zone control device includes the state confirmation section and the power supply control section,
the state confirmation section of the zone control device is configured to determine that the cutoff-allowable state is established when a first waiting time, which is set to be longer than the second waiting time based on the event notification, has elapsed after receiving the event notification, and
the power supply control section of the central control device is configured to bring the power supply switching section into the cutoff state when the state confirmation section determines that the cutoff-allowable state is established.
